(19) United States
(12) Patent Application Publication
(10) Pub. No.: US 2022/0025780 A1
(43) Pub. Date: Jan. 27, 2022

(54) BEARING STRUCTURE AND FLUID MACHINE

(71) Applicant: Panasonic Intellectual Property Management Co., Ltd., Osaka (JP)

(72) Inventors: HIDETOSHI TAGUCHI, Osaka (JP); YOSHIHIRO OKUMURA, Osaka (JP); TAKUMI HIKICHI, Osaka (JP)

(21) Appl. No.: 17/494,212

(22) Filed: Oct. 5, 2021

Related U.S. Application Data
(63) Continuation of application No. PCT/JP2019/047078, filed on Dec. 2, 2019.

(30) Foreign Application Priority Data
Apr. 25, 2019 (JP) 2019-084129

(51) Int. Cl. F01D 25/16; F16C 33/10; F16C 17/10; F04D 29/057

(52) U.S. Cl. CPC F01D 25/166; F16C 33/107; F16C 2360/24; F04D 29/057; F05D 2220/40; F16C 17/107

(57) ABSTRACT

A bearing structure includes a rotating shaft, a thrust collar, and a first thrust bearing. The rotating shaft has a central axis. The thrust collar is mounted on the rotating shaft. The first thrust bearing includes a first dynamic pressure generating mechanism. The first dynamic pressure generating mechanism faces the thrust collar. The relation Rt>Rf1 is satisfied, where Rt represents a length from the central axis to the outer circumferential edge of the thrust collar, and Rf1 represents a length from the central axis to the outer circumferential edge of the first dynamic pressure generating mechanism.

### BACKGROUND

### 1. Technical Field

The present disclosure relates to a bearing structure and a fluid machine.

### 2. Description of the Related Art

In a rotating body, load is generated in the axial direction of a rotating shaft. Thrust bearings are known as bearings that support axial loads. International Publication No. 2014/061698 describes a bearing structure that includes a thrust bearing. FIG. 1 illustrates the bearing structure described in International Publication No. 2014/061698.

The bearing structure illustrated in FIG. 1 includes a rotating shaft 101, a thrust collar 104, a first thrust bearing 103A, and a second thrust bearing 103B. The thrust collar 104 is mounted on the rotating shaft 101. The thrust collar 104 is disposed between the thrust bearings 103A and 103B.

When the rotating shaft 101 rotates at high speed, an axial load is generated in the axial direction of the rotating shaft 101. In addition, when the rotating shaft 101 rotates at high speed, the thrust collar 104 also rotates at high speed. Thus, dynamic pressure is generated between the thrust collar 104 and the thrust bearing 103A. Dynamic pressure is also generated between the thrust collar 104 and the thrust bearing 103B.

The axial load acts to move the thrust collar 104 closer to the first thrust bearing 103A or the second thrust bearing 103B. However, the dynamic pressure generates a repulsive force against this approaching force. In bearing structures that use dynamic pressure, the rotating shaft is thus supported in a contactless manner.

### SUMMARY

The axial load that a thrust bearing can support is sometimes referred to as “load capacity”. If the axial load that exceeds the load capacity is generated, the thrust collar may be brought into physical contact with the thrust bearing and, thus, the thrust bearing may be damaged.

One non-limiting and exemplary embodiment provides a technique suitable for obtaining a large load capacity.

In one general aspect, the techniques disclosed here feature a bearing structure including a rotating shaft having a central axis, a thrust collar mounted on the rotating shaft, and a first thrust bearing including a first dynamic pressure generating mechanism facing the thrust collar. The relation Rt>Rf1 is satisfied, where Rt represents a length from the central axis to an outer circumferential edge of the thrust collar, and Rf1 represents a length from the central axis to the outer circumferential edge of the first dynamic pressure generating mechanism.

The technique according to the present disclosure is suitable for obtaining a large load capacity.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view of an existing bearing structure;

FIG. 2 is a configuration diagram of a fluid machine;

FIG. 3 is a cross-sectional view of a bearing structure;

FIG. 4 is a cross-sectional view of a bearing structure;

FIG. 5 is a cross-sectional view of a bearing structure;

FIG. 6 is a cross-sectional view of a bearing structure;

FIG. 7 is a cross-sectional view of a bearing structure;

FIG. 8 is a plan view of a bearing structure;

FIG. 9 is an enlarged cross-sectional view of the bearing structure;

FIG. 10 is a cross-sectional view of a bearing structure;

FIG. 11A illustrates a mechanism;

FIG. 11B illustrates a mechanism;

FIG. 11C illustrates a mechanism;

FIG. 12 illustrates the results of simulation;

FIG. 13 illustrates the results of simulation;

FIG. 14 illustrates the results of simulation;

FIG. 15 illustrates the results of simulation;

FIG. 16 illustrates the results of simulation;

FIG. 17 illustrates the results of simulation;

FIG. 18 illustrates a dynamic pressure generating mechanism;

FIG. 19A is a plan view of a dynamic pressure generating mechanism;

FIG. 19B is a cross-sectional view of the dynamic pressure generating mechanism;

FIG. 20 is a plan view of a dynamic pressure generating mechanism;

FIG. 21 is a cross-sectional view of a thrust collar;

FIG. 22 is a cross-sectional view of a bearing structure;

FIG. 23 is a cross-sectional view of a bearing structure;

FIG. 24 is a cross-sectional view of a bearing structure;

FIG. 25 is a cross-sectional view of a bearing structure;

FIG. 26 illustrates the flow of working fluid;

FIG. 27 illustrates the flow of working fluid;

FIG. 28 illustrates the flow of working fluid;

FIG. 29 illustrates the flow of working fluid;

FIG. 30 illustrates the flow of working fluid;

FIG. 31 illustrates the flow of working fluid;

FIG. 32 illustrates the displacement of a compressor in an axial direction; and

FIG. 33 is an enlarged cross-sectional view of a bearing structure.

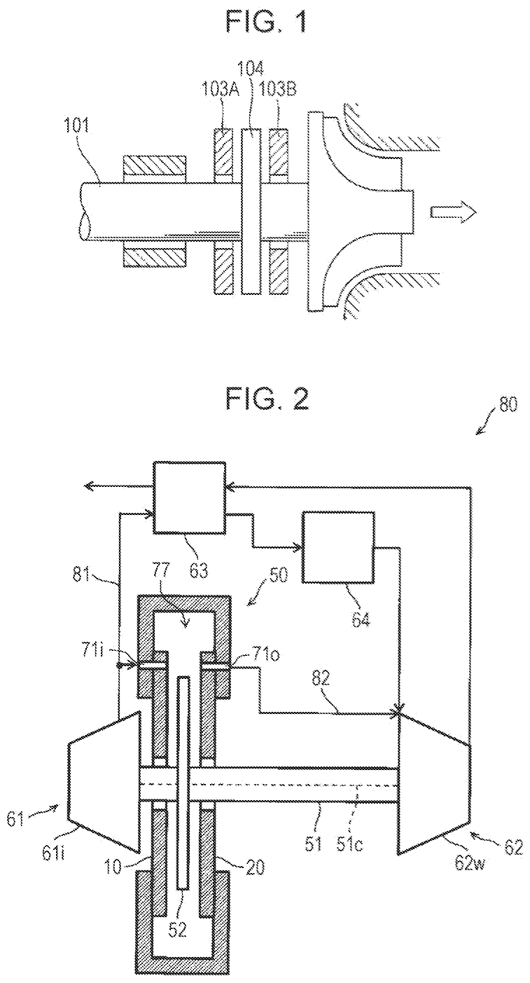

### DETAILED DESCRIPTION

### Overview of Aspect of Disclosure

According to a first aspect of the present disclosure, a bearing structure includes a rotating shaft having a central axis, a thrust collar mounted on the rotating shaft, and a first thrust bearing including a first dynamic pressure generating mechanism facing the thrust collar. The relation Rt>Rf1 is satisfied, where Rt represents a length from the central axis to the outer circumferential edge of the thrust collar, and Rf1 represents a length from the central axis to the outer circumferential edge of the first dynamic pressure generating mechanism.

The first aspect is suitable for obtaining a large load capacity.

According to a second aspect of the present disclosure, for example, in the bearing structure according to the first aspect, the first thrust bearing may include a first stage and a first base. The first stage may extend from the first base toward the thrust collar. The first dynamic pressure generating mechanism may be provided on the first stage, and a relation Rs1<Rb1 may be satisfied, where Rs1 represents a length from the central axis to the outer circumferential edge of the first stage, and Rb1 represents a length from the central axis to the outer circumferential edge of the first base.

The first stage according to the second aspect can contribute to obtaining a large load capacity.

According to a third aspect of the present disclosure, for example, in the bearing structure according to the first or second aspect, the first thrust bearing may include a first stage. The first dynamic pressure generating mechanism may be provided on the first stage, and a relation Rs1<Rt may be satisfied, where Rs1 represents a length from the central axis to the outer circumferential edge of the first stage.

The third aspect is suitable for obtaining a large load capacity.

According to a fourth aspect of the present disclosure, for example, in the bearing structure according to any one of the first to third aspects, the thrust collar may include a first opposing plane that faces the first dynamic pressure generating mechanism and that extends in a direction perpendicular to the central axis, and a relation Ro1>Rf1 may be satisfied, where Ro1 represents a length from the central axis to the outer circumferential edge of the first opposing plane.

The fourth aspect is suitable for obtaining a large load capacity.

According to a fifth aspect of the present disclosure, for example, in the bearing structure according to any one of the first to fourth aspects, the first thrust bearing may include a first stage. The first dynamic pressure generating mechanism may be provided on the first stage, and a relation Rs1>Rf1 may be satisfied, where Rs1 represents a length from the central axis to the outer circumferential edge of the first stage.

The fifth aspect is suitable for obtaining a large load capacity.

According to a sixth aspect of the present disclosure, for example, in the bearing structure according to any one of the first to fifth aspects, the first thrust bearing may include a first stage. The first dynamic pressure generating mechanism may be provided on the first stage. The relation Tf1<Ts1 may be satisfied, where a direction in which the central axis extends is defined as an axial direction, Tf1 represents a dimension of the first dynamic pressure generating mechanism in the axial direction, and Ts1 represents a dimension of the first stage in the axial direction.

The sixth aspect is suitable for obtaining a large load capacity.

According to a seventh aspect of the present disclosure, for example, in the bearing structure according to any one of the first to sixth aspects, the first thrust bearing may include a first stage and a first convex portion. The first dynamic pressure generating mechanism may be provided on the first stage. The first convex portion may extend from the first stage toward the thrust collar. When viewed along the central axis, the first convex portion may be located on the axially outer side of the first dynamic pressure generating mechanism.

The seventh aspect is suitable for obtaining a large load capacity.

According to an eighth aspect of the present disclosure, for example, the bearing structure according to the seventh aspect may satisfy the relation Tf1>Tp1, where a direction in which the central axis extends is defined as an axial direction, Tp1 represents a dimension of the first convex portion in the axial direction, and Tf1 represents a dimension of the first dynamic pressure generating mechanism in the axial direction.

According to the eighth aspect, the first convex portion is unlikely to be brought into contact with the thrust collar.

According to a ninth aspect of the present disclosure, for example, in the bearing structure according to any one of the first to sixth aspects, the first thrust bearing may have a first concave portion, and the first dynamic pressure generating mechanism may be provided in the first concave portion.

The ninth aspect is suitable for obtaining a large load capacity.

According to a tenth aspect of the present disclosure, for example, the bearing structure according to the ninth aspect may satisfy the relation Tf1>Tg1, where a direction in which the central axis extends is defined as an axial direction, Tg1 represents a dimension of the first concave portion in the axial direction, and Tf1 represents a dimension of the first dynamic pressure generating mechanism in the axial direction.

According to the tenth aspect, a part around the first concave portion is unlikely to be brought into contact with the thrust collar.

According to an eleventh aspect of the present disclosure, for example, in the bearing structure according to any one of the first to tenth aspects, the first dynamic pressure generating mechanism may include a plurality of foil strips. The plurality of foil strips may be arranged in an annular pattern so as to surround the rotating shaft, and every adjacent two of the plurality of foil strips may partially overlap each other.

The first dynamic pressure generating mechanism according to the eleventh aspect is a particular example of the first dynamic pressure generating mechanism.

According to a twelfth aspect of the present disclosure, for example, in the bearing structure according to any one of the first to eleventh aspects, the thrust collar may be plane symmetric with respect to a reference plane perpendicular to the central axis.

The twelfth aspect is suitable for preventing the thrust collar from bending during rotation.

According to a thirteenth aspect of the present disclosure, for example, in the bearing structure according to the twelfth aspect, the thrust collar may have a disk portion, a first hub portion, and a second hub portion. The first hub portion and the second hub portion may sandwich the disk portion in an axial direction in which the central axis extends, and the first hub portion may be plane symmetric to the second hub portion with respect to the reference plane.

The thirteenth aspect is suitable for preventing the thrust collar from bending during rotation.

According to a fourteenth aspect of the present disclosure, for example, the bearing structure according to any one of the first to thirteenth aspects may include a casing and an enclosure including the casing and the first thrust bearing. The enclosure may have an internal space. The first dynamic pressure generating mechanism may face the thrust collar in the internal space, and the enclosure may have a first through-hole and a second through-hole that communicate with the internal space.

According to the fourteenth aspect, the working fluid is allowed to flow into the internal space through the first through-hole and flow out of the internal space through the second through-hole. In this way, the temperatures of the thrust collar and the like can be prevented from rising excessively.

According to a fifteenth aspect of the present disclosure, for example, the bearing structure according to the fourteenth aspect may include a heat exchanger. The heat exchanger may partition the internal space into a first space and a second space. The first dynamic pressure generating mechanism may face the thrust collar in the first space, and the first through-hole and the second through-hole may communicate with the second space.

The fifteenth aspect prevents the temperature of the thrust collar and the like from rising excessively, while preventing foreign matter from entering a gap between the first dynamic pressure generating mechanism and the thrust collar.

According to a sixteenth aspect of the present disclosure, a fluid machine may include the bearing structure according to any one of the first to fifteenth aspects, a compressor, and an expander. The compressor and the expander may be mounted on the rotating shaft.

According to the sixteenth aspect, a fluid machine can be achieved that takes advantage of the bearing structure according to any one of the first to fifteenth aspects.

According to a seventeenth aspect of the present disclosure, a fluid machine may include the bearing structure according to the fourteenth or fifteenth aspect, a compressor, and an expander. The compressor and the expander may be mounted on the rotating shaft, and working fluid discharged from the compressor may flow into the internal space through the first through-hole.

According to the seventeenth aspect, the temperatures of the thrust collar and the like can be prevented from rising excessively by the working fluid discharged from the compressor and flowing into the internal space through the first through-hole.

According to an eighteenth aspect of the present disclosure, for example, in the fluid machine according to the seventeenth aspect, the compressor may be a centrifugal compressor. The centrifugal compressor may include a compressor impeller mounted on the rotating shaft. As viewed along the central axis, the first through-hole may be located on the axially outer side of the outer circumferential edge of the compressor impeller.

According to the eighteenth aspect, the flow rate of the working fluid that flows into the internal space through the first through-hole can be easily increased.

According to a nineteenth aspect of the present disclosure, for example, in the fluid machine according to any one of the sixteenth to eighteenth aspects, when a direction in which the central axis extends is defined as an axial direction, the compressor, the thrust collar, and the expander may be arranged in this order in the axial direction, and the relation Lct<Lte may be satisfied, where Lct represents a separation distance between the compressor and the thrust collar in the axial direction, and Lte represents a separation distance between the thrust collar and the expander in the axial direction.

According to the nineteenth aspect, displacement of the compressor in the axial direction caused by a change in temperature of the rotating shaft can be easily prevented.

Exemplary embodiments of the present disclosure are described below with reference to the accompanying drawings. The present disclosure is not limited to the embodiments described below. Unless specifically contradicted herein, the techniques illustrated in each drawing may be combined as appropriate. Hereinafter, description of an example, the embodiment, or the like may be the same as description of a subsequent example or a subsequent embodiment. In such a case, the description is not repeated in the subsequent example, embodiment, or the like, as appropriate.

### First Embodiment

FIG. 2 illustrates a bearing structure 50 according to the first embodiment. The bearing structure 50 includes a rotating shaft 51, a thrust collar 52, and a pair of thrust bearings 10 and 20.

The bearing structure 50 can be employed in a fluid machine that uses a working fluid. The working fluid is typically a compressible fluid. In addition, the working fluid is typically a gas. More specifically, examples of working fluid include air, fluorinated refrigerants, nitrogen (N), neon (Ne), argon (Ar), and helium (He). The fluorinated refrigerant as used herein refers to a refrigerant that contains a component containing fluorine atoms.

The bearing structure 50 can be applied to a variety of systems. In an example illustrated in FIG. 2, the bearing structure 50 is applied to a fluid machine 80. The fluid machine 80 to which the bearing structure 50 is applied is described in detail below.

### Configuration of Bearing Structure

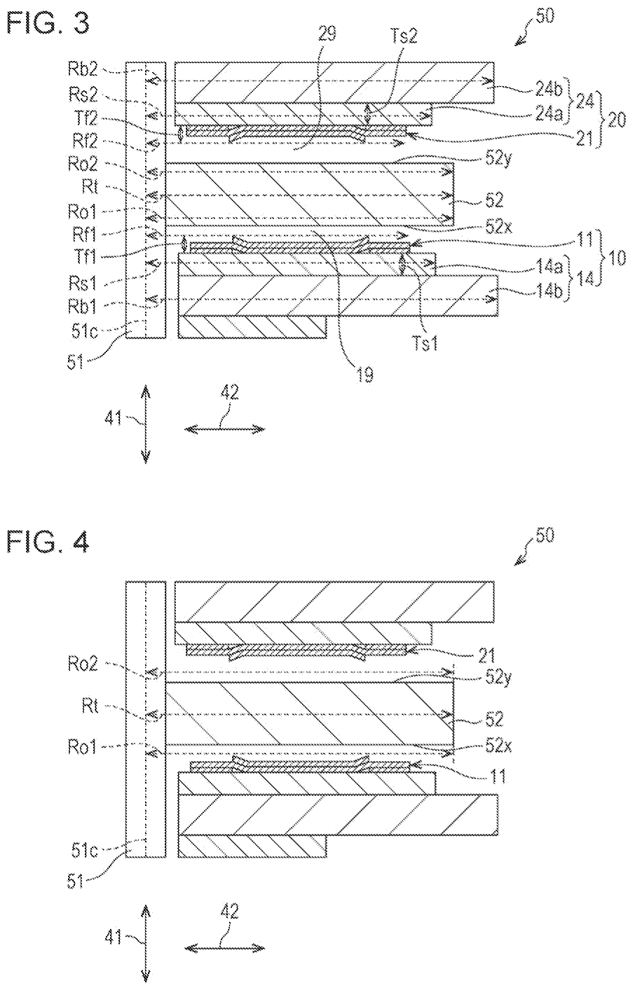

FIG. 3 is a schematic illustration of the bearing structure 50. The bearing structure 50 may include an element not illustrated in FIG. 3. For example, the bearing structure 50 may include a first seal unit that blocks the passage of a working fluid through a gap between the rotating shaft 51 and the thrust bearing 10. The bearing structure 50 may further include a second sealing unit that blocks the passage of the working fluid through a gap between the rotating shaft 51 and the thrust bearing 20.

As illustrated in FIG. 3, the rotating shaft 51 has a central axis 51c. Components, such as a compressor impeller and a turbine wheel, can be mounted on the rotating shaft 51. In this way, a compressor and/or an expander can be achieved in a fluid machine that employs the bearing structure 50.

The thrust collar 52 is mounted on the rotating shaft 51. The thrust collar 52 rotates with the rotating shaft 51.

According to the present embodiment, the thrust collar 52 expands in a radial direction 42. The thrust collar 52 has a disk shape. More specifically, when viewed in the axial direction 41, the thrust collar 52 has a circular shape. The thrust collar 52 is disposed coaxially with the rotating shaft 51.

Note that the axial direction 41 is the direction in which the central axis 51c extends. The radial direction 42 is the radial direction of the rotating shaft 51. The axial direction 41 and the radial direction 42 are mutually perpendicular. Hereinafter, the outer side in the radial direction 42 is also referred to as a radially outer side, and the inner side in the radial direction 42 is also referred to as a radially inner side. In addition, the term “circumferential direction 43” may be used hereafter. The circumferential direction 43 is a direction around the central axis 51c.

The thrust collar 52 has a first opposing plane 52x and a second opposing plane 52y. The planes 52x and 52y are located on either side of the thrust collar 52 in the axial direction 41.

The first opposing plane 52x faces a first dynamic pressure generating mechanism 11. The first opposing plane 52x extends in all directions perpendicular to the central axis 51c of the rotating shaft 51.

The second opposing plane 52y faces a second dynamic pressure generating mechanism 21. The second opposing plane 52y extends in all direction perpendicular to the central axis 51c of the rotating shaft 51.

In reality, the dimensions, angles, and the like of elements in the bearing structure 50 may have errors from the design values within tolerance. Dimensions, angles, and the like that deviate from those described in the present embodiment within tolerance are regarded as the same as the dimensions, angles, and the like described in the present embodiment. For example, a plane that extends in a direction substantially perpendicular to the rotating shaft while deviating from the perpendicular direction within tolerance can correspond to the first opposing plane 52x. In addition, such a plane can correspond to the second opposing plane 52y.

The thrust bearings 10 and 20 that form a pair are disposed on either side of the thrust collar 52 in the axial direction 41 of the rotating shaft 51. The pair of thrust bearings 10 and 20 consist of a first thrust bearing 10 and a second thrust bearing 20. According to the present embodiment, the thrust bearings 10 and 20 are gas bearings. More specifically, the thrust bearings 10 and 20 are hydrodynamic gas bearings.

The first thrust bearing 10 includes the first dynamic pressure generating mechanism 11 and a first substrate 14. The second thrust bearing 20 includes the second dynamic pressure generating mechanism 21 and a second substrate 24.

The first substrate 14 includes a first stage 14a and a first base 14b. The first stage 14a extends from the first base 14b toward the thrust collar 52.

The second substrate 24 includes a second stage 24a and a second base 24b. The second stage 24a extends from the second base 24b toward the thrust collar 52.

The first dynamic pressure generating mechanism 11 faces the thrust collar 52. The first dynamic pressure generating mechanism 11 is provided on the first substrate 14. More specifically, the first dynamic pressure generating mechanism 11 is provided on the first stage 14a.

The second dynamic pressure generating mechanism 21 faces the thrust collar 52. The second dynamic pressure generating mechanism 21 is provided on the second substrate 24. More specifically, the second dynamic pressure generating mechanism 21 is provided on the second stage 24a.

The dynamic pressure generating mechanisms 11 and 21 generate dynamic pressure. In the bearing structure 50, the rotating shaft 51 is supported in a contactless manner by using the dynamic pressure generated by the dynamic pressure generating mechanisms 11 and 21.

More specifically, the rotating shaft 51 rotates at high speed with a gap 19 formed between the first dynamic pressure generating mechanism 11 and the thrust collar 52. When the rotating shaft 51 rotates at high speed, the thrust collar 52 also rotates at high speed. As a result, dynamic pressure is generated in the gap 19.

In addition, the rotating shaft 51 rotates at high speed with a gap 29 formed between the second dynamic pressure generating mechanism 21 and the thrust collar 52. When the rotating shaft 51 rotates at high speed, the thrust collar 52 also rotates at high speed. As a result, dynamic pressure is generated in the gap 29.

The bearing structure 50 is described in more detail below. In the following description, the terms length Rt, length Ro1, length Ro2, length Rf1, length Rf2, length Rs1, length Rs2, length Rb1, length Rb2, dimension Tf1, dimension Tf2, dimension Ts1, and dimension Ts2 may be used.

The length Rt is the length from the central axis 51c of the rotating shaft 51 to the outer circumferential edge of the thrust collar 52. The length Ro1 is the length from the central axis 51c to the outer circumferential edge of the first opposing plane 52x. The length Ro2 is the length from the central axis 51c to the outer circumferential edge of the second opposing plane 52y.

The length Rf1 is the length from the central axis 51c of the rotating shaft 51 to the outer circumferential edge of the first dynamic pressure generating mechanism 11. The length Rf2 is the length from the central axis 51c to the outer circumferential edge of the second dynamic pressure generating mechanism 21.

The length Rs1 is the length from the central axis 51c of the rotating shaft 51 to the outer circumferential edge of the first stage 14a. The length Rs2 is the length from the central axis 51c to the outer circumferential edge of the second stage 24a.

The length Rb1 is the length from the central axis 51c of the rotating shaft 51 to the outer circumferential edge of the first base 14b. The length Rb2 is the length from the central axis 51c to the outer circumferential edge of the second base 24b.

The dimension Tf1 is the dimension of the first dynamic pressure generating mechanism 11 in the axial direction 41. The dimension Tf2 is the dimension of the second dynamic pressure generating mechanism 21 in the axial direction 41.

The dimension Ts1 is the dimension of the first stage 14a in the axial direction 41. The dimension Ts2 is the dimension of the second stage 24a in the axial direction 41. Hereinafter, the dimension Ts1 is also referred to as a height Ts1. The dimension Ts2 is also referred to as a height Ts2.

As can be seen from FIG. 3, the relation Rt>Rf1 is satisfied in the bearing structure 50. In addition, the relation Rt>Rf2 is satisfied. Since these relations are satisfied, a large load capacity is suitably obtained. In this context, the term “load capacity” refers to the axial load that the thrust bearing can support.

For example, 0<Rt−Rf1<1000 μm. In addition, 0<Rt−Rf2<1000 μm. In one specific example, 250 μm<Rt−Rf1<750 μm. In addition, 250 μm<Rt−Rf2<750 μm.

According to the present embodiment, the relation Rs1<Rb1 is satisfied. When this relation is satisfied, the presence of the first stage 14a can contribute to obtaining a large load capacity. In addition, according to the present embodiment, the relation Rs2<Rb2 is satisfied.

According to the present embodiment, the relation Rs1<Rt is satisfied. In addition, the relation Rs2<Rt is satisfied. Since these relations are satisfied, a large load capacity is suitably obtained.

Alternatively, the relation Rt=Rs1 may be satisfied. Still alternatively, the relation Rt=Rs2 may be satisfied.

More specifically, the relation Rt−600 μm<Rs1 Rt may be satisfied. The relation Rt−600 μm<Rs2 Rt may be satisfied. Still more specifically, the relation Rt−300 μm<Rs1<Rt may be satisfied. The relation Rt−300 μm<Rs2≤Rt may be satisfied.

According to the present embodiment, the relation Ro1>Rf1 is satisfied. In addition, the relation Ro2>Rf2 is satisfied. Since these relations are satisfied, a large load capacity is suitably obtained.

The relation Ro1>Rf1 and the relation Ro2>Rf2 are described in more detail with reference to FIGS. 4 to 6. The examples in FIGS. 4 to 6 are encompassed within the scope of the present disclosure.

FIG. 4 illustrates a bearing structure 50 that is the same as in FIG. 3. In the example in FIG. 4, the surface of the thrust collar 52 facing the first dynamic pressure generating mechanism 11 is perpendicular to the central axis 51c throughout the length up to its the outer circumferential edge. For this reason, Ro1=Rt. In addition, the surface of the thrust collar 52 facing the second dynamic pressure generating mechanism 21 is perpendicular to the central axis 51c throughout the length up to up to its outer circumferential edge. For this reason, Ro2=Rt. In the example in FIG. 4, the relations Rt>Rf1, Rt>Rf2, Ro1>Rf1, and Ro2>Rf2 are satisfied.

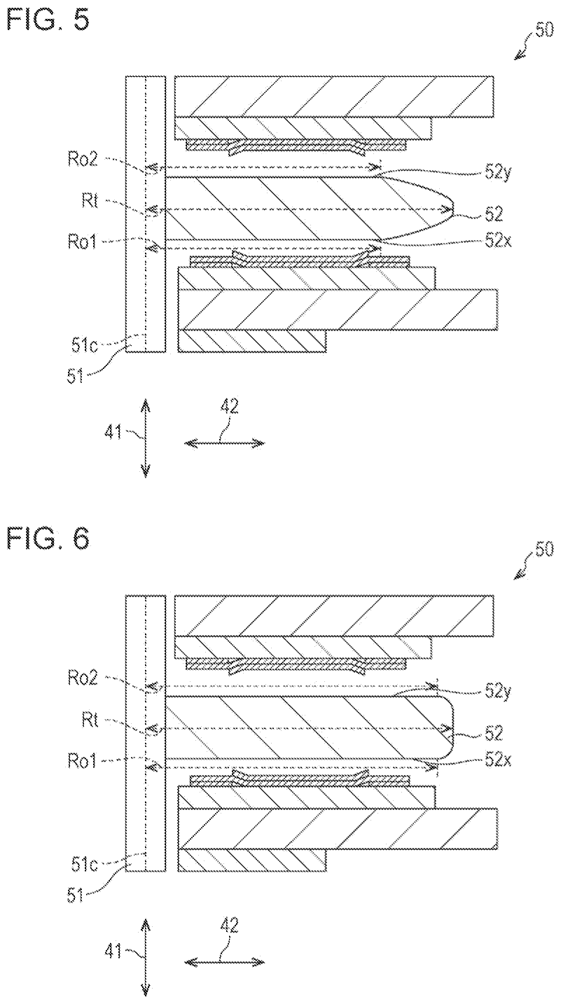

The example in FIG. 5 is a modification of the thrust collar 52 in the example in FIG. 4. More specifically, in the example in FIG. 5, the outer circumferential edge of the thrust collar 52 is chamfered. For this reason, Ro1≠Rt, and Ro2≠Rt. In the example in FIG. 5, the chamfered area is large. For this reason, the relation Rt>Rf1 and the relation Rt>Rf2 are satisfied, but neither Ro1>Rf1 nor Ro2>Rf2 is satisfied.

The example in FIG. 6 is a modification of the thrust collar 52 in the example in FIG. 4. In the example in FIG. 6, the outer circumferential edge of the thrust collar 52 is chamfered. For this reason, Ro1≠Rt, and Ro2≠Rt. However, in the example in FIG. 6, the area that is chamfered is small. For this reason, although the outer circumferential edge of the thrust collar 52 is chamfered, the relations Rt>Rf1, Rt>Rf2, Ro1>Rf1, and Ro2>Rf2 are satisfied.

Due to chamfering as illustrated in FIGS. 5 and 6, the thrust collar 52 is less likely to be brought into contact with the thrust bearings 10 and 20. Furthermore, according to the structure illustrated in FIG. 6, the relations Rt>Rf1, Rt>Rf2, Ro1>Rf1, and Ro2>Rf2 can be satisfied while maintaining the effect of chamfering.

In the examples in FIG. 4 and FIG. 6, the relations Rs1<Rt, Rs2<Rt, Rs1<Ro1, and Rs2<Ro2 are all satisfied. In the example in FIG. 5, the relations Rs1<Rt and Rs2<Rt are all satisfied, but neither the relation Rs1<Ro1 nor Rs2<Ro2 is satisfied.

Referring back to FIG. 3, according to the present embodiment, the relation Rs1>Rf1 is satisfied. In addition, the relation Rs2>Rf2 is satisfied. In this way, a decrease in static pressure between the first stage 14a and the thrust collar 52 can be easily avoided. In addition, a decrease in static pressure between the second stage 24a and the thrust collar 52 can be easily avoided. This is suitable for obtaining a large load capacity.

According to the present embodiment, the relation Tf1<Ts1 is satisfied. In addition, the relation Tf2<Ts2 is satisfied. In this way, it is easy to obtain Ts1 and Ts2 with sufficient values. Therefore, it is easy to prevent the flow of the working fluid between the gap 19 and the space on the first base 14b and, thus, to prevent a decrease in the static pressure between the first stage 14a and the thrust collar 52. Furthermore, it is easy to prevent the flow of the working fluid between the gap 29 and the space on the second base 24b and, thus, to prevent a decrease in static pressure between the second stage 24a and the thrust collar 52. This is suitable for obtaining a large load capacity. Note that in this context, the space on the first base 14b corresponds to a free space FS (described below).

For example, Ts1>500 μm. In addition, Ts2>500 μm. For example, Ts1<2000 μm. In addition, Ts2<2000 μm.

According to the present embodiment, in a support mode in which the first thrust bearing 10 supports the rotating shaft 51 that is rotating, the dimension Ts1 is greater than the separation distance between the first stage 14a and the thrust collar 52 in the axial direction 41 at the outer circumferential edge of the first stage 14a. Similarly, in a support mode in which the second thrust bearing 20 supports the rotating shaft 51 that is rotating, the dimension Ts2 is greater than the separation distance between the second stage 24a and the thrust collar 52 in the axial direction 41 at the outer circumferential edge of the second stage 24a.

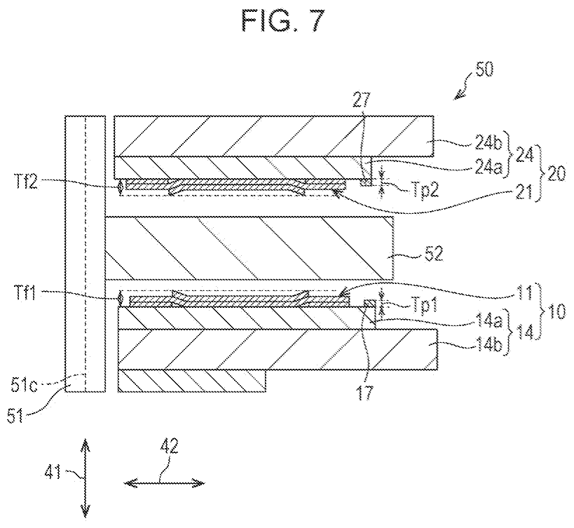

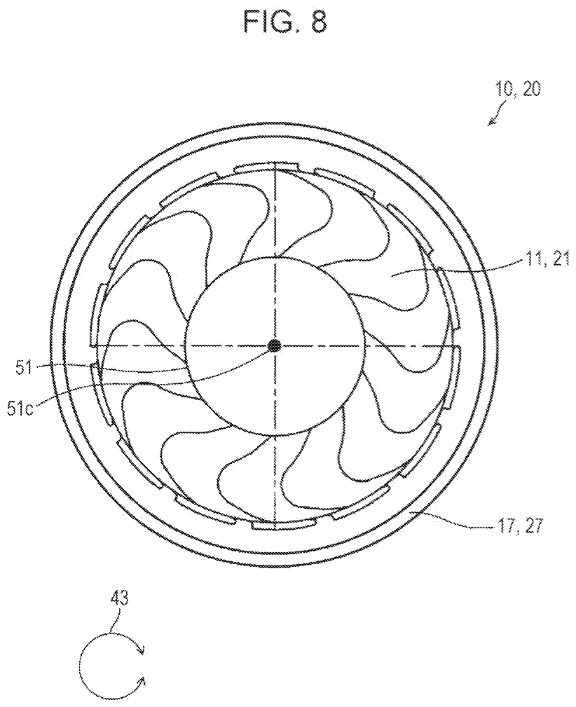

The examples in FIGS. 7 to 9 can also be employed. The examples in FIGS. 7 to 9 are obtained by adding a first convex portion 17 and a second convex portion 27 to the example in FIG. 4. Although both description of the first convex portion 17 and description of the second convex portion 27 are given with reference to FIG. 8, this does not necessarily mean that the first convex portion 17 and the second convex portion 27 have the same dimensions, shape, and the like.

In the examples in FIGS. 7 to 9, the first thrust bearing 10 includes the first convex portion 17. The first convex portion 17 protrudes from the first stage 14a toward the thrust collar 52. When viewed along the central axis 51c, the first convex portion 17 is located on the radially outer side of the first dynamic pressure generating mechanism 11. In this way, the path of the working fluid between the gap 19 and the space on the first base 14b can be reduced in width. In this manner, the flow from the gap 19 to the space on the first base 14b can be prevented and, thus, a decrease in static pressure between the first stage 14a and the thrust collar 52 can be easily prevented. This is suitable for obtaining a large load capacity.

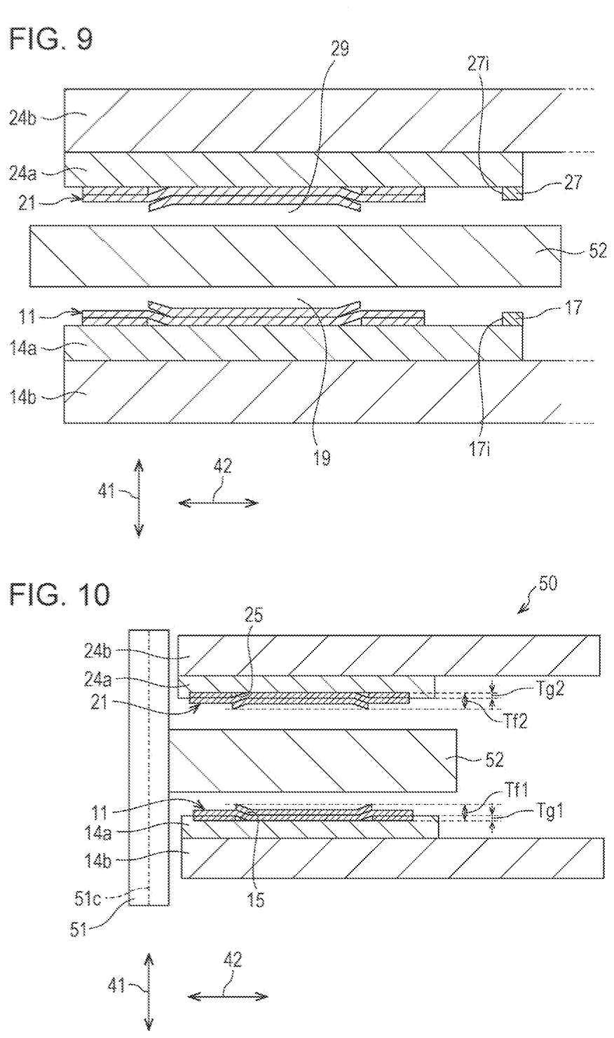

Let Tp1 denote the dimension of the first convex portion 17 in the axial direction 41. Then, in a typical example, the relation Tf1>Tp1 is satisfied, as illustrated in FIGS. 7 and 9. Therefore, the first convex portion 17 is farther away from the thrust collar 52 than the first dynamic pressure generating mechanism 11 in the axial direction 41. In this way, the first convex portion 17 is less likely to be brought into contact with the thrust collar 52. Note that hereinafter, the dimension Tp1 is also referred to as the height Tp1.

In a typical example, when viewed along the central axis 51c, the first convex portion 17 is separated from the first dynamic pressure generating mechanism 11. In this way, the first dynamic pressure generating mechanism 11 can be easily installed. The separation distance is, for example, greater than or equal to 100 μm and less than or equal to 500 μm.

However, the first convex portion 17 may be in contact with the first dynamic pressure generating mechanism 11, when viewed along the central axis 51c. In this way, a large load capacity can be easily obtained.

In a typical example, as illustrated in FIG. 8, when viewed along the central axis 51c, the first convex portion 17 has a frame shape surrounding the first dynamic pressure generating mechanism 11. More specifically, this frame shape is an annular shape.

In a typical example, as illustrated in FIG. 9, the first convex portion 17 has a first inner peripheral surface 17i. The first inner peripheral surface 17i extends in the axial direction 41. In this way, the effect of the first convex portion 17 to prevent a decrease in the static pressure can be prominent. In the example in FIG. 9, when viewed along the central axis 51c, the first inner peripheral surface 17i is located on the radially outer side of the outer circumferential edge of the first dynamic pressure generating mechanism 11 and on the radially inner side of the outer circumferential edge of the thrust collar 52.

The height Tp1 is, for example, greater than or equal to 10 μm. The height Tp1 is, for example, greater than or equal to ⅓ of the dimension Tf1. The height Tp1 is, for example, less than or equal to ⅔ of the dimension Tf1.

In the examples in FIGS. 7 to 9, the second thrust bearing 20 includes the second convex portion 27. The second convex portion 27 protrudes from the second stage 24a toward the thrust collar 52. When viewed along the central axis 51c, the second convex portion 27 is located on the axially outer side of the second dynamic pressure generating mechanism 21.

Let Tp2 denote the dimension of the second convex portion 27 in the axial direction 41. Then, in a typical example, the relation Tf2>Tp2 is satisfied, as illustrated in FIGS. 7 and 9. Therefore, the second convex portion 27 is farther away from the thrust collar 52 than the second dynamic pressure generating mechanism 21 in the axial direction 41. Hereinafter, the dimension Tp2 is also referred to as the height Tp2.

In a typical example, the second convex portion 27 is separated from the second dynamic pressure generating mechanism 21 when viewed along the central axis 51c. This separation distance is, for example, greater than or equal to 100 μm and less than or equal to 500 μm.

However, when viewed along the central axis 51c, the second convex portion 27 may be in contact with the second dynamic pressure generating mechanism 21.

In a typical example, as illustrated in FIG. 8, when viewed along the central axis 51c, the second convex portion 27 has a frame shape surrounding the second dynamic pressure generating mechanism 21. More specifically, this frame shape is an annular shape.

In a typical example, as illustrated in FIG. 9, the second convex portion 27 has a second inner peripheral surface 27i. The second inner peripheral surface 27i extends in the axial direction 41. In the example in FIG. 9, when viewed along the central axis 51c, the second inner peripheral surface 27i is located on the axially outer side of the outer circumferential edge of the second dynamic pressure generating mechanism 21 and on the axially inner side of the outer circumferential edge of the thrust collar 52.

The height Tp2 is, for example, greater than or equal to 10 μm. The height Tp2 is, for example, greater than or equal to ⅓ of the dimension Tf2. The height Tp2 is, for example, less than or equal to ⅔ of the dimension Tf2.

The example in FIG. 10 can also be employed. The example in FIG. 10 is obtained by forming a first concave portion 15 and a second concave portion 25 in the example in FIG. 4.

In the example in FIG. 10, the first thrust bearing 10 has the first concave portion 15. More specifically, the first stage 14a has the first concave portion 15. The first dynamic pressure generating mechanism 11 is provided in the first concave portion 15. In this way, the amount of hydraulic fluid flowing out in the radially outward direction through the gap 19 between the first dynamic pressure generating mechanism 11 and the thrust collar 52 can be reduced. For this reason, this structure is suitable for obtaining a large load capacity.

Let Tg1 denote the dimension of the first concave portion 15 in the axial direction 41. Then, in the typical case, the relation Tf1>Tg1 is satisfied, as illustrated in FIG. 10. Therefore, the first dynamic pressure generating mechanism 11 protrudes from the first concave portion 15. In this way, a portion surrounding the first concave portion 15 is less likely to be brought into contact with the thrust collar 52. Note that hereinafter, the dimension Tg1 is also referred to as a depth Tg1.

The depth Tg1 is, for example, greater than or equal to 10 μm. The depth Tg1 is, for example, greater than or equal to ⅓ of the dimension Tf1. The depth Tg1 is, for example, less than or equal to ⅔ of the dimension Tf1.

In the example in FIG. 10, the second thrust bearing 20 has the second concave portion 25. More specifically, the second stage 24a has the second concave portion 25. The second dynamic pressure generating mechanism 21 is provided in the second concave portion 25.

Let Tg2 denote the dimension of the second concave portion 25 in the axial direction 41. Then, in a typical example, the relation Tf2>Tg2 is satisfied, as illustrated in FIG. 10. Therefore, the second dynamic pressure generating mechanism 21 protrudes from the second concave portion 25. Note that hereinafter, the dimension Tg2 is also referred to as a depth Tg2.

The depth Tg2 is, for example, greater than or equal to 10 μm. The depth Tg2 is, for example, greater than or equal to ⅓ of the dimension Tf1. The depth Tg2 is, for example, less than or equal to ⅔ of the dimension Tf2.

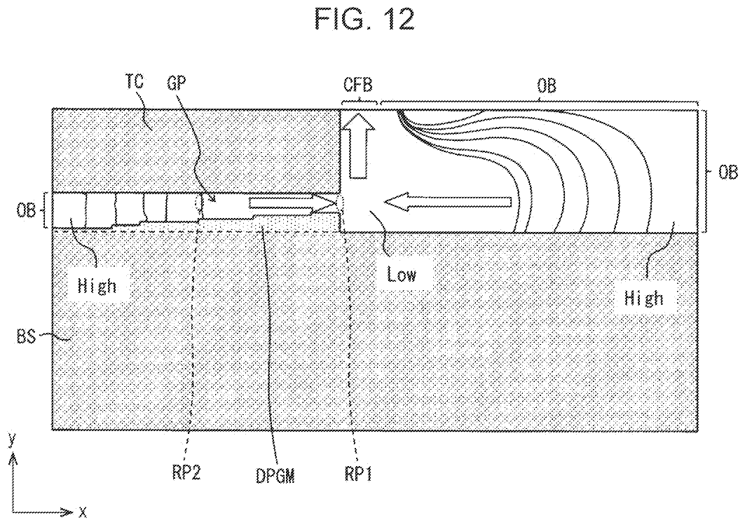

To increase the load capacity of the bearing structure 50, the present inventors focused their study on the structure of the outer circumferential portions of the dynamic pressure generating mechanisms 11 and 21. The present inventors postulated that the pressure in the gap 19 between the dynamic pressure generating mechanism 11 and the thrust collar 52 and the pressure in the gap 29 between the dynamic pressure generating mechanism 21 and the thrust collar 52 depended on the structure of the outer circumferential portions of the dynamic pressure generating mechanisms 11 and 21. Accordingly, the present inventors actually fabricated a bearing structure 50 illustrated in FIG. 3. The inventors measured the load capacity of the fabricated bearing structure 50 and confirmed that the load capacity of the bearing structure 50 was increased by adopting the structure illustrated in FIG. 3. Furthermore, the inventors verified the mechanism that increased the load capacity through simulation. The simulation is described below with reference to FIGS. 12 to 17.

### Mechanism M

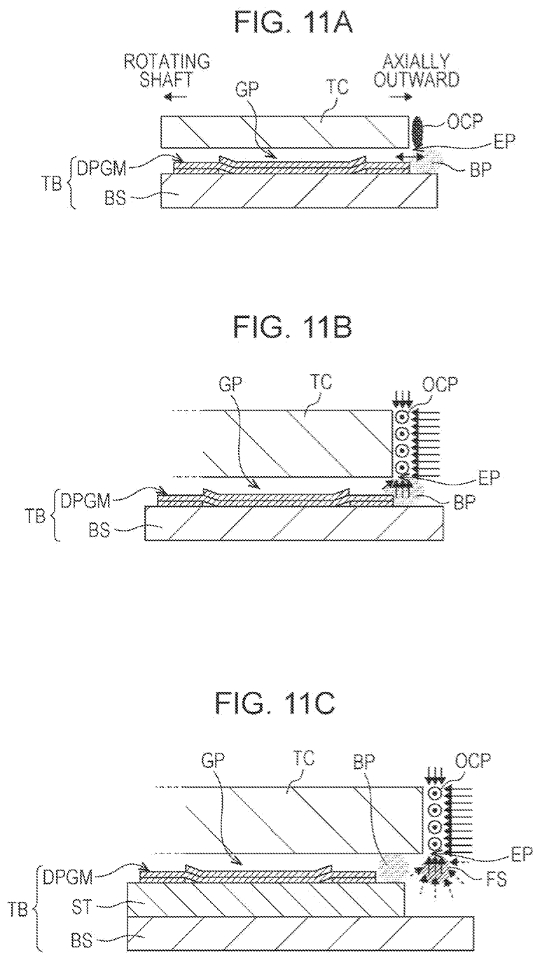

The inventors examined the reason why a large load capacity can be obtained by setting Rt>Rf1 and Rs1<Rt. More specifically, the inventors assumed that the mechanism M described below worked in the bearing structure 50 and, thus, a large load capacity was able to be obtained, and verified the mechanism. The mechanism M is described below with reference to FIGS. 11A to 11C. The description of mechanism M is not to be construed as limiting the present disclosure.

FIGS. 11A to 11C are schematic illustrations to describe the mechanism M. In the following description, it is assumed that the working fluid is a gas.

In FIG. 11A, a boundary portion BP refers to a portion immediately outside the outer circumference of a dynamic pressure generating mechanism DPGM. A radially outward portion OCP refers to a portion immediately outside the outer circumference of the thrust collar TC. The end EP refers to the end of radially outward portion OCP adjacent to the thrust bearing TB. The gap GP refers to the gap between the dynamic pressure generating mechanism DPGM and the thrust collar TC.

The mechanism M prevents a decrease in load capacity caused by suction of gas by the end EP. The mechanism M is further described below with reference to comparison of FIG. 11B and FIG. 11C. In FIGS. 11B and 11C, the outer circumferential edge of the thrust collar TC is rotating in the direction out of the plane of FIG. 11B and FIG. 11C.

In FIG. 11B, the length from the central axis of the rotating shaft to the outer circumferential edge of the thrust collar TC is equal to the length from the central axis of the rotating shaft to the outer circumferential edge of the dynamic pressure generating mechanism DPGM. The length from the central axis of the rotating shaft to the outer circumferential edge of the base BS is greater than the length from the central axis of the rotating shaft to the outer circumferential edge of the thrust collar TC. The dynamic pressure generating mechanism DPGM is provided on the base BS.

In the situation illustrated in FIG. 11B, the following phenomena are likely to occur. That is, the thrust collar TC rotates at high speed; the gas in the radially outward portion OCP rotates at high speed in a direction the same as the direction of rotation of the thrust collar TC, causing airflow to occur in the radially outward portion OCP; the static pressure at the end EP decreases; and the gas is sucked from the boundary portion BP to the end EP, causing the static pressure of the boundary portion BP to decrease (b1). In addition, the gas is sucked directly from the gap GP to the end EP (b2).

In contrast, in FIG. 11C, the length from the central axis of the rotating shaft to the outer circumferential edge of the thrust collar TC is greater than the length from the central axis of the rotating shaft to the outer circumferential edge of the dynamic pressure generating mechanism DPGM. The stage ST is interposed between the base BS and the dynamic pressure generating mechanism DPGM. The length from the central axis of the rotating shaft to the outer circumferential edge of the stage ST is less than the length from the central axis of the rotating shaft to the outer circumferential edge of the thrust collar TC. The dynamic pressure generating mechanism DPGM is provided on that stage ST.

In the situation illustrated in FIG. 11C, the following phenomena are likely to occur. That is, the thrust collar TC rotates at high speed; the gas in the radially outward portion OCP rotates at high speed in a direction the same as the direction of rotation of the thrust collar TC, causing airflow to occur in the radially outward portion OCP; the static pressure at the end EP decreases; however, in the case illustrated in FIG. 11C, since the end EP is far away from the dynamic pressure generating mechanism DPGM, the end EP does not directly reduce the static pressure in the boundary portion BP (c1); and since the end EP is located on the radially outer side of the stage ST, the gas is sucked from the free space FS around the boundary portion BP to the end EP and, thus, the static pressure reduced at the end EP is less likely to propagate to the boundary portion BP (c2).

From the viewpoint of obtaining a large load capacity, the above-described phenomena (b1) and (b2) in the case illustrated in FIG. 11B are disadvantageous. However, the above-described phenomena (c1) and (c2) in the case illustrated in FIG. 11C are advantageous to obtaining a large load capacity. Note that it is not essential to interpose the stage ST as in FIG. 11C. Even when the stage ST is not provided, a large load capacity can be obtained on the basis of the phenomenon (c1) described above.

Note that in FIG. 11C, the free space FS functions as a source of gas supply to the end EP. For this reason, in FIG. 11C, the decrease in static pressure at the end EP is easily prevented.

### Simulation

FIGS. 12 to 17 illustrate the two-dimensional simulation result obtained by using Flowsquare, which is thermo-fluid simulation software available from Nora Scientific. In the simulations illustrated in FIGS. 12 to 17, a constant flow boundary CFB and an open boundary OB are given. In the constant flow boundary CFB, the flow rate of gas is constant. In the open boundary OB, the reference pressure is set to P0, and the gas can pass through. In the simulations illustrated in FIGS. 12 to 17, the constituent elements of the bearing structure, including the thrust collar, are stationary. This setting differs from the reality. However, by giving a constant flow boundary CFB, the flow of the working fluid that occurs when the thrust collar is rotating is simulated.

In FIGS. 12 to 17, the curved lines schematically represent a change in the level of static pressure. In FIGS. 12 to 17, the right direction is also referred to as the x-direction and the upward direction as the y-direction. The x-direction corresponds to the radial direction 42 that extends outwardly. The y-direction corresponds to one of the two axial directions 41.

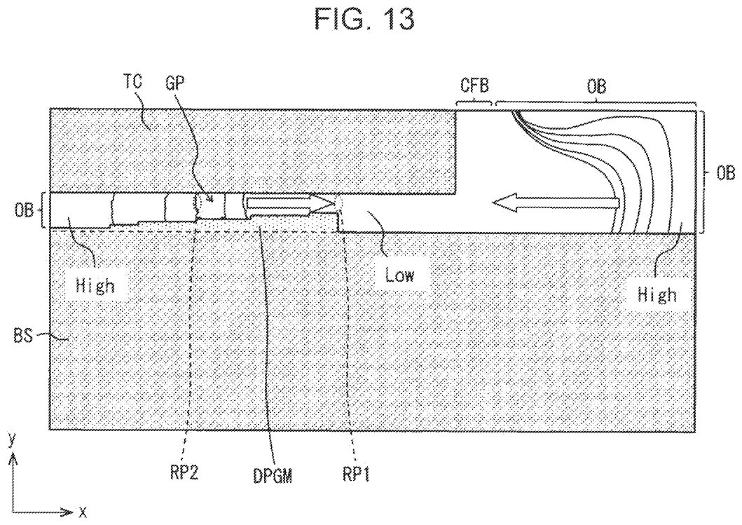

### (Rt>Rf1: FIGS. 12 and 13)

As can be seen from the simulation results in FIGS. 12 and 13, the relation Rt>Rf1 is suitable for obtaining a large load capacity.

More specifically, the simulation illustrated in FIG. 12 is simulation under the condition Rt=Rf1. More specifically, the x coordinate representing the outer circumferential edge of the thrust collar TC is the same as the x coordinate representing the outer circumferential edge of the dynamic pressure generating mechanism DPGM.

In the simulation illustrated in FIG. 12, a stationary thrust collar TC, a stationary dynamic pressure generating mechanism DPGM, and a stationary base BS are given in the simulation space. The dynamic pressure generating mechanism DPGM is provided on the base BS. By causing the working fluid to flow out of the constant flow boundary CFB to the outside of the simulation space, the situation in which the working fluid is sucked from a region adjacent to the base BS to the radially outward portion OCP of the thrust collar TC is simulated, and the distribution of the static pressure in this situation is calculated. The “High” region in FIG. 12 is a region for which the calculation result indicating high static pressure is obtained. The “Low” region is a region for which a calculation result indicating low static pressure is obtained. As can be seen from the distribution of the static pressure and the action of the constant flow boundary CFB, the flow of the working fluid is generated as indicated by the arrows in FIG. 12.

Unlike the simulation illustrated in FIG. 12, the simulation illustrated in FIG. 13 is simulation under the condition Rt>Rf1. More specifically, the x coordinate representing the outer circumferential edge of the thrust collar TC is greater than the x coordinate representing the outer circumferential edge of the dynamic pressure generating mechanism DPGM.

In the simulations illustrated in FIGS. 12 and 13, a first reference point RP1 is set on the same coordinates in the vicinity of the outer circumferential edge of the dynamic pressure generating mechanism DPGM. In the simulations illustrated in FIGS. 12 and 13, a second reference point RP2 is set on a position on the radially inner side of the first reference point RP1 on the dynamic pressure generating mechanism DPGM. In terms of coordinates in the simulation space, the x coordinate of the first reference point RP1 is greater than the x coordinate of the second reference point RP2.

In the simulations illustrated in FIGS. 12 and 13, the static pressure P1 at the first reference point RP1, the static pressure P2 at the second reference point RP2, the difference ΔP1 (=P0−P1) between the reference pressure P0 and the first pressure P1, and the difference ΔP2 (=P0−P2) between the reference pressure P0 and the second pressure P2 are calculated. When ΔP1 in the simulation illustrated in FIG. 12 is normalized to 100, ΔP1 in the simulation illustrated in FIG. 13 is 70.3. When ΔP2 in the simulation illustrated in FIG. 12 is normalized to 100, ΔP2 in the simulation illustrated in FIG. 13 is 68.6. This result indicates that in the case of Rt>Rf1, it is easier to prevent a decrease in the static pressure at the immediate outside of the dynamic pressure generating mechanism and, thus, prevent a decrease in the static pressure in the gap between the dynamic pressure generating mechanism and the thrust collar than in the case of Rt=Rf1. Thus, it is easier to obtain a larger load capacity.

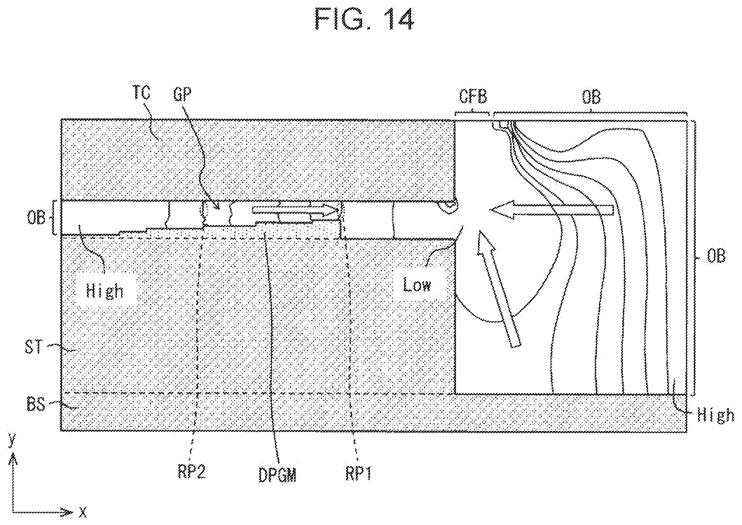

### (Rs1<Rb1: FIG. 14)

As can be seen from the simulation result in FIG. 14, to obtain a large load capacity, it is desirable that the first stage 14a be interposed between the first base 14b and the first dynamic pressure generating mechanism 11, the condition Rs1<Rb1 be satisfied, and the first dynamic pressure generating mechanism 11 be provided on the first stage 14a. Note that as described above, the length Rb1 is the length from the central axis 51c to the outer circumferential edge of the first base 14b. The length Rs1 is the length from the central axis 51c to the outer circumferential edge of the first stage 14a.

More specifically, unlike the simulation illustrated in FIG. 13, the stage ST is interposed between the base BS and the dynamic pressure generating mechanism DPGM in the simulation illustrated in FIG. 14. The simulation illustrated in FIG. 14 is simulation under the condition Rs1<Rb1. More specifically, the x coordinate representing the outer circumferential edge of the stage ST is less than the x coordinate representing the outer circumferential edge of the base BS. In addition, the simulation illustrated in FIG. 14 is simulation under the condition Rt=Rs1. More specifically, the x coordinate representing the outer circumferential edge of the thrust collar TC is the same as the x coordinate representing the outer circumferential edge of the stage ST.

In the simulation illustrated in FIG. 14, the first reference point RP1 and the second reference point RP2 are set on the same coordinates as in the simulations illustrated in FIGS. 12 and 13. In the simulation illustrated in FIG. 14, the static pressure P1 at the first reference point RP1, the static pressure P2 at the second reference point RP2, the difference ΔP1 (=P0−P1) between the reference pressure P0 and the first pressure P1, and the difference ΔP2 (=P0−P2) between the reference pressure P0 and the second pressure P2 are calculated. When ΔP1 in the simulation illustrated in FIG. 12 is normalized to 100, ΔP1 in the simulation illustrated in FIG. 14 is 23.6. When ΔP2 in the simulation illustrated in FIG. 12 is normalized to 100, ΔP2 in the simulation illustrated in FIG. 14 is 21.6. The values of ΔP1 and ΔP2 in the simulation illustrated in FIG. 14 are less than those in the simulation illustrated in FIG. 13. As can be seen from the result, to prevent a decrease in the static pressure in a portion immediately outside the outer circumference of the dynamic pressure generating mechanism, prevent a decrease in the static pressure in the gap between the dynamic pressure generating mechanism and the thrust collar and, thus, obtain a large load capacity, it is desirable that the first stage 14a be interposed between the first base 14b and the first dynamic pressure generating mechanism 11, the relation Rs1<Rb1 be satisfied, and the first dynamic pressure generating mechanism 11 be provided on the first stage 14a.

As can be seen from the distribution of the static pressure indicated by the simulation result in FIG. 14, the flow of the working fluid indicated by the arrows is generated. Comparison of FIG. 13 and FIG. 14 indicates that the presence of the stage ST expands the path of fluid that flows in a direction of decreasing the x coordinate and increasing the y coordinate and enters the gap GP between the dynamic pressure generating mechanism DPGM and the thrust collar TC. It is presumed that this expansion contributes to a decrease in each of ΔP1 and ΔP2. Note that the direction of decreasing the x coordinate and increasing the y-coordinate corresponds to a direction oriented from a radially outward portion to a radially inward portion and oriented from the base BS to the gap GP.

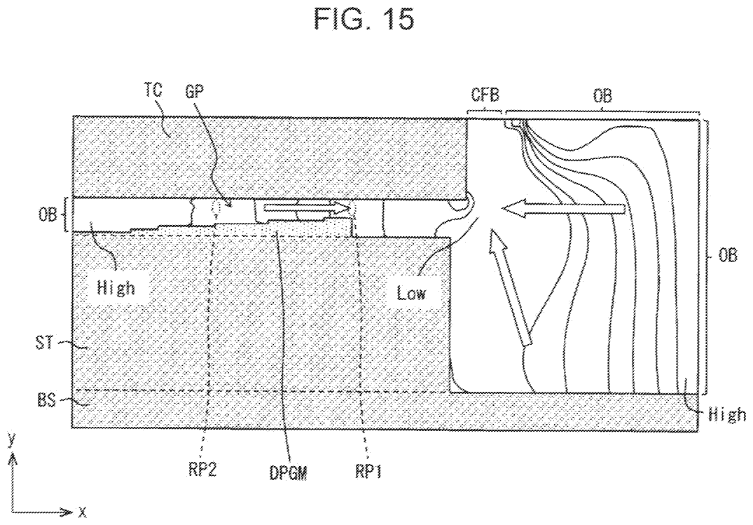

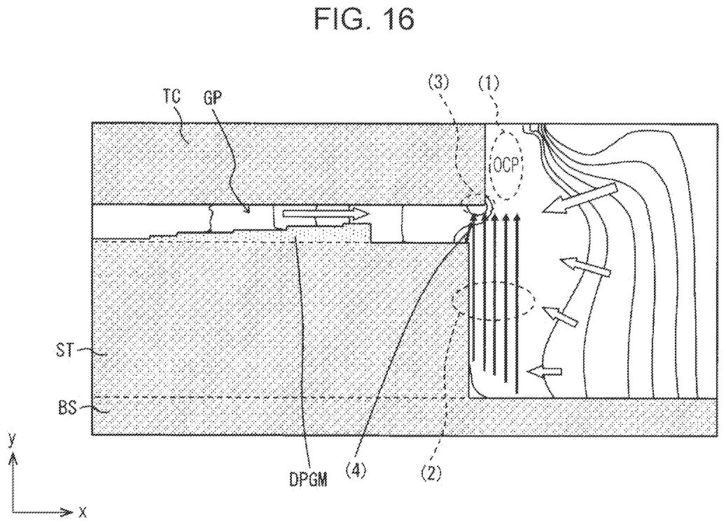

### (Rs1<Rt: FIGS. 15 and 16)

As can be seen from the simulation result in FIG. 15, to obtain a large load capacity, it is desirable that the relation Rs1<Rt be satisfied.

More specifically, unlike the simulation illustrated in FIG. 14, the simulation illustrated in FIG. 15 is simulation under the condition Rs1<Rt. Still more specifically, unlike the simulation illustrated in FIG. 14, the x coordinate representing the outer circumferential edge of the stage ST is less than the x coordinate representing the outer circumferential edge of the thrust collar TC in the simulation illustrated in FIG. 15.

In the simulation illustrated in FIG. 15, the first reference point RP1 and the second reference point RP2 are set on the same coordinates as those in the simulations illustrated in FIGS. 12 to 14. In addition, in the simulation illustrated in FIG. 15, the static pressure P1 at the first reference point RP1, the static pressure P2 at the second reference point RP2, the difference ΔP1 (=P0−P1) between the reference pressure P0 and the first pressure P1, and the difference ΔP2 (=P0−P2) between the reference pressure P0 and the second pressure P2 are calculated. When ΔP1 in the simulation illustrated in FIG. 12 is normalized to 100, ΔP1 in the simulation illustrated in FIG. 15 is 22.2. When the ΔP2 in the simulation illustrated in FIG. 12 is normalized to 100, the ΔP2 in the simulation illustrated in FIG. 15 is 19.6. The values ΔP1 and ΔP2 in the simulation illustrated in FIG. 15 are less than those in the simulation illustrated in FIG. 14. This result indicates that in the case of Rs1<Rt, it is easier to prevent a decrease in static pressure in a portion immediately outside the outer circumference of a dynamic pressure generating mechanism than in the case of Rt=Rs1 and it is easier to prevent the decrease in static pressure in the gap between the dynamic pressure generating mechanism and the thrust collar. Thus, it is easier to obtain a larger load capacity.

In the case of Rs1<Rt, the phenomena described below may occur. FIG. 16 is FIG. 15 with an additional note to describe the phenomena. As illustrated in FIG. 16, the following descriptions (1), (2), (3) and (4) are likely to be valid in this order:

(1) The static pressure in the radially outward portion OCP of the thrust collar TC is reduced, and a static pressure distribution is formed so that the flow of the working fluid to the radially outward portion OCP is easily generated.

(2) This causes the flow of the working fluid from the base BS to the radially outward portion OCP, that is, the flow of the working fluid in substantially the y-direction.

(3) Part of the working fluid flowing in substantially the y-direction collides with the thrust collar TC, and the static pressure increases in the vicinity of the collision area.

(4) Part of the outlet of the working fluid flowing from the gap GP between the thrust collar TC and the stage ST in the radially outward direction is occupied by a high-pressure region formed as in description (3) above, and the flow of working fluid is blocked.

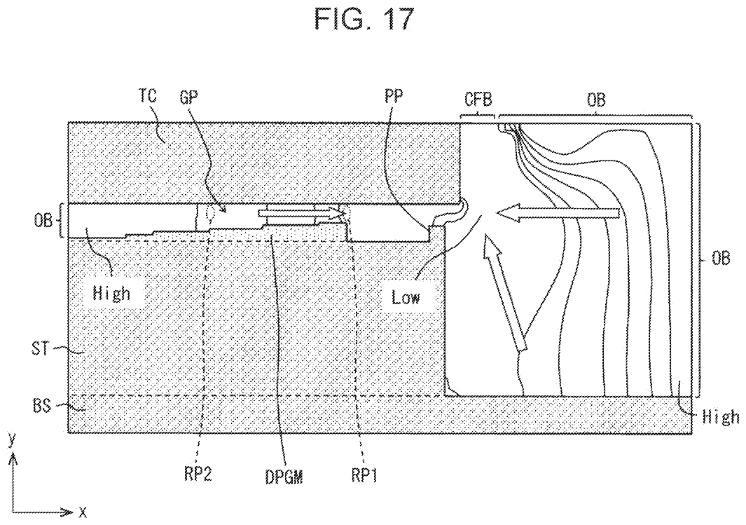

### (First Convex Portion 17: FIG. 17)

Unlike the simulation illustrated in FIG. 14, the first convex portion 17 is simulated in the simulation illustrated in FIG. 17. More specifically, a convex portion PP is provided in the simulation illustrated in FIG. 17.

In the simulation illustrated in FIG. 17, the first reference point RP1 and the second reference point RP2 are set on the same coordinates as in the simulations illustrated in FIGS. 12 to 15. In the simulation illustrated in FIG. 17, the static pressure P1 at the first reference point RP1, the static pressure P2 at the second reference point RP2, the difference ΔP1 (=P0−P1) between the reference pressure P0 and the first pressure P1, and the difference ΔP2 (=P0−P2) between the reference pressure P0 and the second pressure P2 are calculated. When ΔP1 in the simulation illustrated in FIG. 12 is normalized to 100, ΔP1 in the simulation illustrated in FIG. 17 is 17.9. When ΔP2 in the simulation illustrated in FIG. 12 is normalized to 100, ΔP2 in the simulation illustrated in FIG. 17 is 17.6. The values ΔP1 and ΔP2 in the simulation illustrated in FIG. 17 are less than those in the simulation illustrated in FIG. 14. This result indicates that when the first convex portion 17 is provided, it is easier to prevent a decrease in static pressure in the portion immediately outside the outer circumference of a dynamic pressure generating mechanism and a decrease in static pressure in the gap between the dynamic pressure generating mechanism and the thrust collar than when the first convex portion 17 is not provided. Thus, a larger load capacity can be easily obtained.

### Configuration of Dynamic Pressure Generating Mechanism

A variety of dynamic pressure generating mechanisms can be used as the dynamic pressure generating mechanisms 11 and 21.

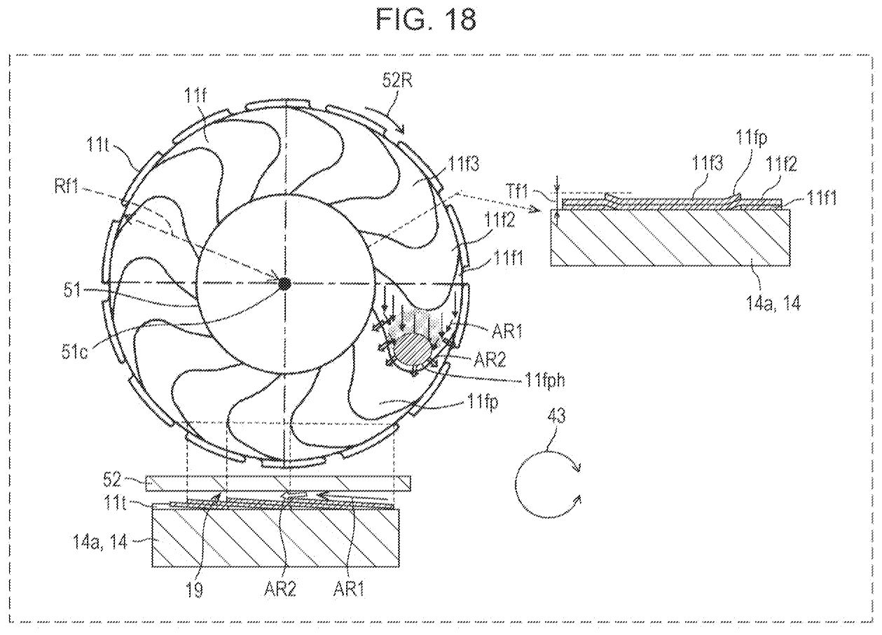

The first dynamic pressure generating mechanism 11 in the examples in FIGS. 4 to 17 is described with reference to FIG. 18. In the example in FIG. 18, the first dynamic pressure generating mechanism 11 includes a plurality of foil strips 11f. The plurality of foil strips 11f are arranged in an annular pattern so as to surround the rotating shaft 51. Every adjacent two of the foil strips 11f partially overlap.

In the example in FIG. 18, each of the foil strips 11f has a protruding portion 11fp. The protruding portion 11fp of one foil strip 11f overlaps the top of the other foil strip 11f. Such overlap is formed repeatedly by the plurality of foil strips 11f.

In the example in FIG. 18, one end of the foil strip 11f adjacent to the protruding portion 11fp in the circumferential direction 43 is a free end. The foil strip 11f is fixed by a mounting portion 11t.

The thickness of each of the foil strip 11f is, for example, in the range of 40 μm to 200 μm.

The operation performed by the first dynamic pressure generating mechanism 11 illustrated in FIG. 18 is described below.

When the thrust collar 52 rotates in a rotational direction 52R, the working fluid in the gap 19 between the first dynamic pressure generating mechanism 11 and the thrust collar 52 rotates as it is dragged by the rotation. The working fluid dragged in this manner is led to the protruding portion 11fp. The protruding portion 11fp is relatively close to the thrust collar 52 because it overlaps another foil strip 11f. As a result, a narrowed portion is intermittently formed between the protruding portion 11fp and the thrust collar 52, and the pressure increases when the working fluid passes through the narrowed portion. As the working fluid intermittently passes through the narrowed portion in the circumferential direction 43, the pressure is intermittently increased, which supports the rotating shaft 51.

More specifically, as illustrated in FIG. 18, a region 11fph with high static pressure is formed on the protruding portion 11fp. The region 11fph supports the thrust load. Closed arrows AR1 and open arrows AR2 are drawn in the vicinity of the region 11fph in FIG. 18. In addition, the arrows AR1 and AR2 are drawn in the cross-sectional view in the lower left of FIG. 18.

The closed arrows AR1 schematically illustrate how the working fluid is accelerated by the rotation of the thrust collar 52. In the region in which such acceleration takes place, the inclination formed by the foil strips 11f generates dynamic pressure, which supports the static pressure gradient. The open arrows AR2 schematically illustrate how the working fluid flows out due to the difference between the total pressure in the high pressure region 11fph of one foil strip 11f and the static pressure in the low pressure region of the adjacent foil strip 11f. As used herein, the term “total pressure in the high pressure region 11fph” refers to the sum of the static pressure and the dynamic pressure in the high pressure region 11fph.

A cross-sectional view parallel to the radial direction 42 is illustrated in the upper right of FIG. 18. The cross-sectional view indicates how the three foil strips 11f (that is, foil strips 11f1, 11f2 and 11f3) that are adjacent to each other overlap.

In the example in FIG. 18, the outer circumferential edge of the first dynamic pressure generating mechanism 11 is the outer circumferential edge of the foil strip 11f. For this reason, the length Rf1 from the central axis 51c of the rotating shaft 51 to the outer circumferential edge of the first dynamic pressure generating mechanism 11 is defined as illustrated in FIG. 18.

In the example in FIG. 18, the dimension Tf1 of the first dynamic pressure generating mechanism 11 in the axial direction 41 is the maximum height of the protruding portion 11fp from the first substrate 14, which depends on the thicknesses of the plurality of foil strips 11f.

Bearings that employ the hydrodynamic pressure generating mechanism of the example in FIG. 18 are sometimes called leaf type foil bearings.

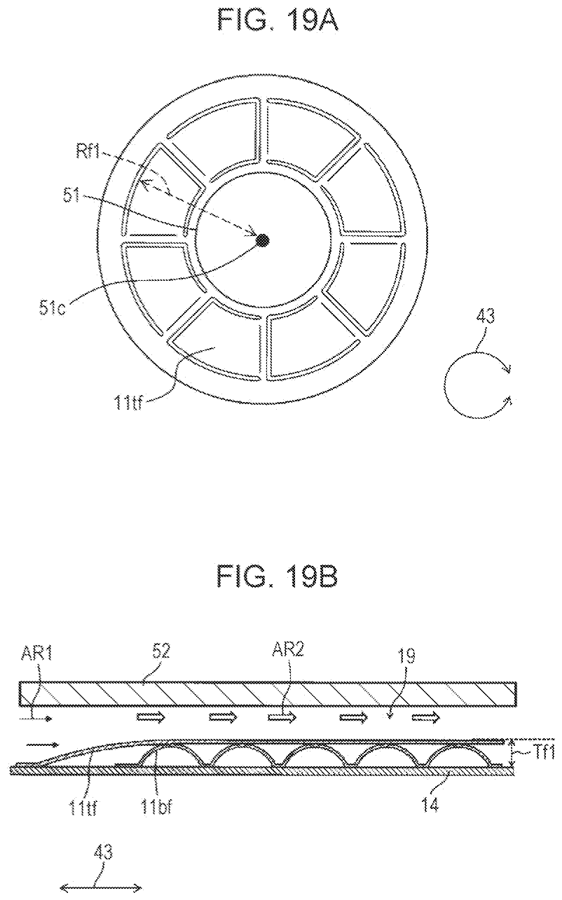

Another example of the first dynamic pressure generating mechanism 11 is illustrated in FIGS. 19A and 19B. In the example in FIGS. 19A and 19B, the first dynamic pressure generating mechanism 11 includes a top foil 11tf and a bump foil 11bf. The top foil 11tf faces the thrust collar 52. The bump foil 11bf has a continuous arch shape. The bump foil 11bf elastically supports the top foil 11tf. One end of the top foil 11tf in the circumferential direction 43 is a fixed end that is fixed to the first substrate 14, and the other end is a free end. Part of the bump foil 11bf is fixed to the substrate 14.

FIG. 19B is a cross-sectional view of the first dynamic pressure generating mechanism 11 parallel to the circumferential direction 43. During rotation of the thrust collar 52, the pressure of the working fluid in the gap 19 supports the rotating shaft 51.

In FIGS. 19A and 19B, the outer circumferential edge of the first dynamic pressure generating mechanism 11 is the outer circumferential edge of the top foil 11ff. For this reason, the length Rf1 from the central axis 51c of the rotating shaft 51 to the outer circumferential edge of the first dynamic pressure generating mechanism 11 is defined as illustrated in FIG. 19A.

In the examples in FIGS. 19A and 19B, the dimension Tf1 of the first dynamic pressure generating mechanism 11 in the axial direction 41 is the maximum height of the top foil 11tf from the substrate 14, which depends on the shape of the bump foil 11bf and the thicknesses of the bump foil 11bf and top foil 11tf.

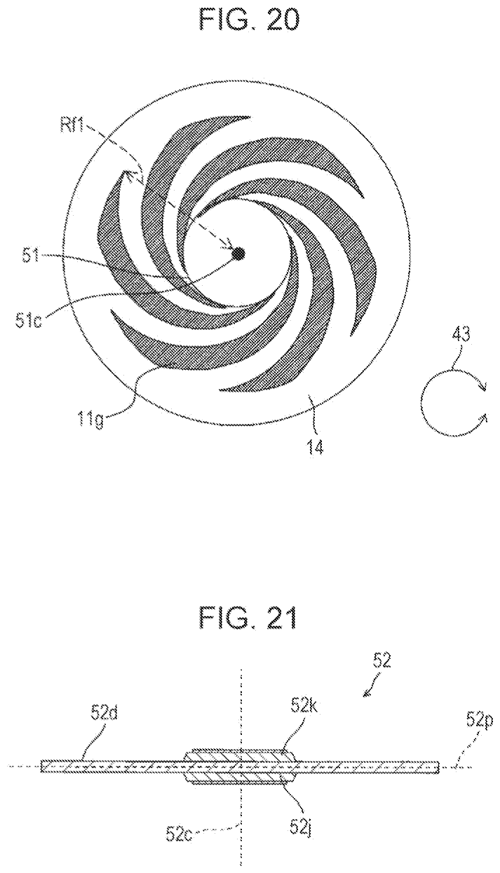

Another example of the first dynamic pressure generating mechanism 11 is illustrated in FIG. 20. In the example in FIG. 20, the first dynamic pressure generating mechanism 11 has a plurality of spiral-shaped grooves 11g. The plurality of grooves 11g extend radially from the rotating shaft 51. The plurality of grooves 11g are provided in the first substrate 14.

In the first dynamic pressure generating mechanism 11 illustrated in FIG. 20, the rotating shaft 51 is supported by the pressure of the working fluid in the gap 19 during the rotation of the thrust collar 52.

In the example in FIG. 20, the outer circumferential edge of the first dynamic pressure generating mechanism 11 is the outer circumferential edge of the groove 11g. For this reason, the length Rf1 from the central axis 51c of the rotating shaft 51 to the outer circumferential edge of the first dynamic pressure generating mechanism 11 is defined as illustrated in FIG. 20.

In the example in FIG. 20, the dimension Tf1 of the first dynamic pressure generating mechanism 11 in the axial direction 41 is the depth of the groove 11g.

Bearings that employ the dynamic pressure generating mechanism of the example in FIG. 20 are sometimes called spiral groove bearings.

The example of the first dynamic pressure generating mechanism 11 illustrated in FIGS. 18 to 20 is also applicable to the second dynamic pressure generating mechanism 21. In such application, the terminology may be changed as appropriate, such as changing “first” to “second”.

### Structure of Thrust Collar

As described above, according to the present embodiment, the thrust collar 52 is a disk in shape. In a typical example, the thrust collar 52 is made of metal.

FIG. 21 illustrates the thrust collar 52 according to the present embodiment. The thrust collar 52 illustrated in FIG. 21 is plane symmetric with respect to a reference plane 52p perpendicular to the central axis 51c of the rotating shaft 51.

More specifically, the thrust collar 52 in FIG. 21 includes a disk portion 52d, a first hub portion 52j, and a second hub portion 52k. The first hub portion 52j and the second hub portion 52k sandwich the disk portion 52d in the axial direction 41 in which the central axis 51c extends. The first hub portion 52j is plane symmetric to the second hub portion 52k with respect to the reference plane 52p. In a typical example, the disk portion 52d, the first hub portion 52j, and the second hub portion 52k are single components. Such a single member can be fabricated, for example, by integral molding.

If the thrust collar 52 is not plane symmetrical with respect to the reference plane 52p, the thrust collar 52 tends to bend toward the portion having a larger thickness due to the centrifugal force during rotation. The tendency becomes prominent when the diameter of the thrust collar 52 is increased. In this respect, the plane symmetry of the thrust collar 52 illustrated in FIG. 21 can reduce the bend of the thrust collar 52 during rotation.

Even when the thrust collar 52 is composed only of the disk portion 52d, the thrust collar 52 can be plane symmetrical with respect to the reference plane 52p. However, a further effect can be achieved by providing the first hub portion 52j and the second hub portion 52k and making the thrust collar 52 plane symmetric with respect to the reference plane 52p.

More specifically, to enable the thrust collar 52 composed only of a disk portion 52d to withstand the stress generated by high-speed rotation, the thickness of the disk portion 52d can be increased. However, if the thickness is increased, the mass of the disk portion 52d increases and, thus, the mass of the rotating system tends to increase. If the mass of the rotating system increases, the bending resonance eigenvalue of the rotating system tends to decrease. The decrease in the bending resonance eigenvalue means that the rotational speed at which the vibration of the rotating system becomes prominent decrease. Therefore, when the bending resonance eigenvalue is low, it is difficult to rotate the rotating system at high speed. In contrast, if the thrust collar 52 has hub portions 52j and 52k, the thickness of the disk portion 52d can be easily reduced. Therefore, the bending resonance eigenvalue of the rotating system can be easily increased, and the rotating system can be easily rotated at high speed. Note that in this context, the term “rotating system” refers to a combination of the rotating shaft 51 and the elements rotating with the rotating shaft 51. The elements that rotate with the rotating shaft 51 can include the thrust collar 52, a compressor impeller, and a turbine wheel.

Note that the bending resonance eigenvalue is a parameter that is sometimes referred to as the bending critical resonance frequency, bending critical speed, or bending resonance frequency.

### Casing

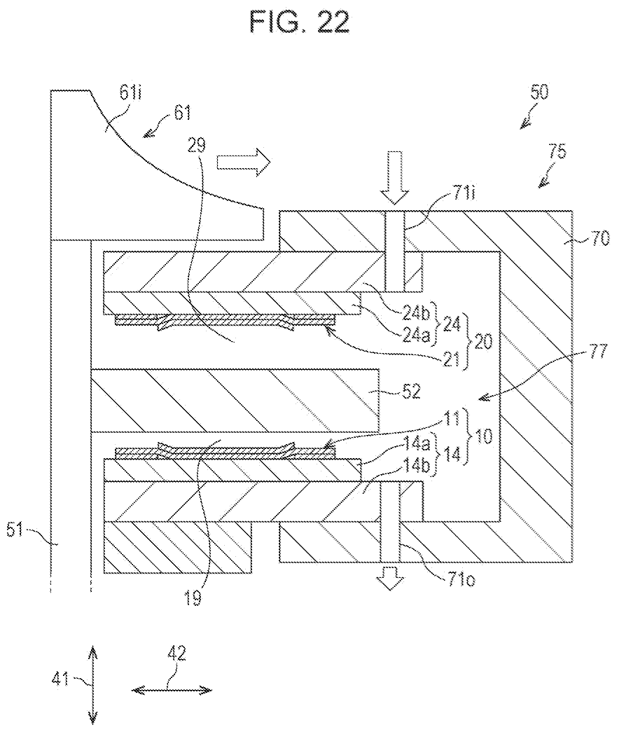

In the example in FIG. 22, the bearing structure 50 includes a casing 70. An enclosure 75 is provided that includes the casing 70, the first thrust bearing 10, and the second thrust bearing 20. The enclosure 75 has an internal space 77. In the internal space 77, the first dynamic pressure generating mechanism 11 faces the thrust collar 52. In the internal space 77, the second dynamic pressure generating mechanism 21 faces the thrust collar 52. The enclosure 75 has a first through-hole 71i and a second through-hole 71o that communicate with the internal space 77.

When the thrust collar 52 rotates, a flow of working fluid occurs, and the working fluid has kinetic energy. When the working fluid loses its kinetic energy, heat energy is generated.

In this regard, the first through-hole 71i and the second through-hole 71o described above can prevent the temperature of the thrust collar 52 and the like from rising excessively. More specifically, in the example in FIG. 22, the working fluid can flow into the internal space 77 through the first through-hole 71i and flow out of the internal space 77 through the second through-hole 71o. In this way, the temperature of the thrust collar 52 and the like can be prevented from rising excessively. In the example in FIG. 22, the first through-hole 71i is the inlet of the working fluid. The second through-hole 71o is an outlet of the working fluid.

Note that, in general, the pressure generated by the dynamic pressure generating mechanism to support the thrust collar is approximately proportional to the density p of the working fluid. As the temperature of the working fluid increases, the density p decreases. In this regard, in the example in FIG. 22, the first through-hole 71i is provided in the thrust bearing 20, and the second through-hole 71o is provided in the thrust bearing 10. In this way, the temperature of the working fluid in the gaps 29 and 19 is easily decreased, and the density p is easily increased. Thus, the pressure to support the thrust collar generated by the dynamic pressure generating mechanism is easily ensured. This is advantageous from the perspective of obtaining a large load capacity.

More specifically, in the example in FIG. 22, the first through-hole 71i is provided on the radially outer side of the second stage 24a in the thrust bearing 20. The second through-hole 71o is provided on the radially outer side of the first stage 14a in the thrust bearing 10. More specifically, the first through-hole 71i is provided in the second base 24b. The second through-hole 71o is provided in the first base 14b.

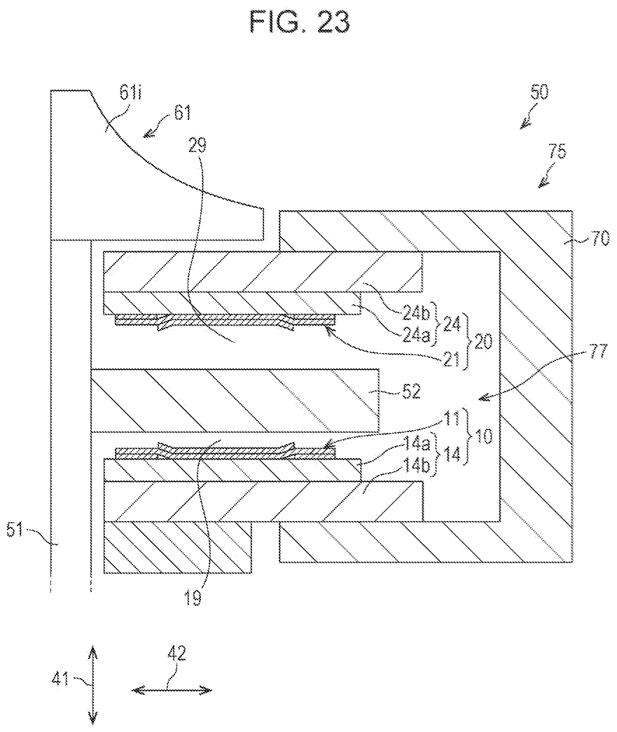

However, as illustrated in FIG. 23, a configuration in which the enclosure 75 does not have the first through-hole 71i and the second through-hole 71o can be adopted. Even in such a case, heat control can be performed by using a material having an excellent thermal conductivity as the material for the casing 70.

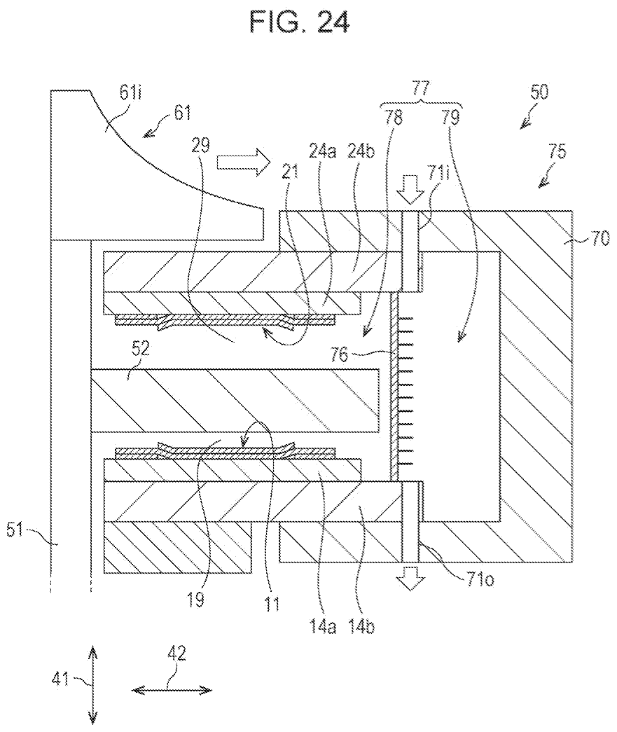

In the example in FIG. 24, the bearing structure 50 includes a heat exchanger 76. The heat exchanger 76 partitions the internal space 77 into a first space 78 and a second space 79. In the first space 78, the first dynamic pressure generating mechanism 11 faces the thrust collar 52. In the first space 78, the second dynamic pressure generating mechanism 21 faces the thrust collar 52. The first through-hole 71i and the second through-hole 71o communicate with the second space 79.

According to the heat exchanger 76 described above, the temperature of the thrust collar and the like can be prevented from rising excessively while preventing foreign matter, such as dust and dirt, from entering the gap between the dynamic pressure generating mechanism and the thrust collar.

The heat exchanger 76 is not limited to any particular type of heat exchanger. In the example in FIG. 24, the heat exchanger 76 has fins. More specifically, in the example in FIG. 24, the heat exchanger 76 has corrugated fins. Other examples of the heat exchanger 76 include a plate heat exchanger, a shell and tube heat exchanger, and a fin tube heat exchanger 76.

In the example in FIG. 24, the heat exchanger 76 partitions the first space 78 from the second space 79 without any gap. Such a configuration is suitable for preventing foreign matter from entering the gap between the dynamic pressure generating mechanism and the thrust collar in the first space 78.

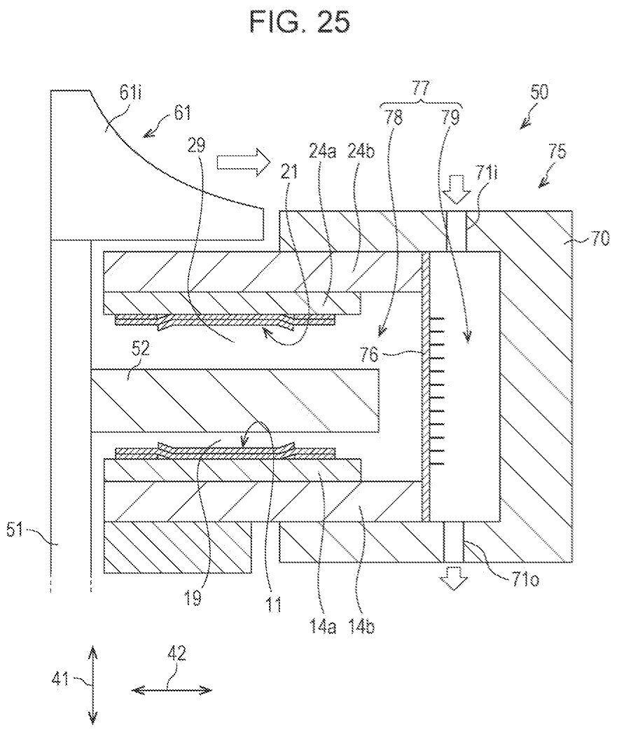

In the example in FIG. 24, the first through-hole 71i penetrates both the second base 24b and the casing 70. However, as illustrated in FIG. 25, the first through-hole 71i may penetrate the casing 70 without penetrating the second base 24b. In addition, in the example in FIG. 24, the second through-hole 71o penetrates both the first base 14b and the casing 70. However, as illustrated in FIG. 25, the second through-hole 71o may penetrate the casing 70 without penetrating the first base 14b. This configuration is also applied to the example in FIG. 22.

### Fluid Machine

The bearing structure 50 described with reference to FIGS. 3 to 25 is applicable to the fluid machine 80. An example of the fluid machine 80 is described in FIG. 2. In FIG. 2, the flow of fluid is indicated by arrows.

In the example in FIG. 2, the fluid machine 80 includes a compressor 61 and an expander 62. The compressor 61 and the expander 62 are mounted on the rotating shaft 51. More specifically, the compressor 61 and the expander 62 are mechanically mounted on the rotating shaft 51. The fluid machine 80 further include a regenerative heat exchanger 63 and a combustor 64.

In the example in FIG. 2, the compressor 61 is a centrifugal compressor. The centrifugal compressor 61 includes a compressor impeller 61i and a diffuser. The compressor impeller 61i of the centrifugal compressor 61 is mounted (mechanically in the specific example) on the rotating shaft 51. The diffuser is located on the radially outer side of the compressor impeller 61i. The working fluid can pass through the compressor impeller 61i first and, thereafter, the diffuser. Note that in FIG. 2, the diffuser is not illustrated. This also applies to FIGS. 22 to 25.

In the example in FIG. 2, the fluid machine 80 is a turbine system. The expander 62 is an expansion turbine.

More specifically, in the example in FIG. 2, the expansion turbine 62 is a radial expansion turbine. The radial expansion turbine 62 includes a turbine wheel 62w and a nozzle. The turbine wheel 62w is mounted (mechanically in the specific example) on the rotating shaft 51. The nozzle is located on the radially outer side of the turbine wheel 62w. Combustion gas from the combustor 64 can pass through the nozzle first and, thereafter, the turbine wheel 62w. Note that the nozzle is not illustrated in FIG. 2.

In the example in FIG. 2, the compressor 61, the thrust collar 52, and the expander 62 are installed in this order in the axial direction 41. More specifically, the compressor impeller 61i, the thrust collar 52, and the turbine wheel 62w are installed in this order in the axial direction 41.

In the example in FIG. 2, the working fluid discharged from the compressor 61 flows into the internal space 77 through the first through-hole 71i. In this manner, the temperature of the thrust collar 52 and the like can be prevented from rising excessively.

More specifically, in the example in FIG. 2, a first flow channel 81 and a second flow channel 82 are provided.

The first flow channel 81 connects the compressor 61 to the combustor 64 to the expander 62. More specifically, the first flow channel 81 connects the compressor 61 to the regenerative heat exchanger 63 to the combustor 64 to the expander 62 to the regenerative heat exchanger 63.

The second flow channel 82 bypasses the combustor 64. More specifically, the second flow channel 82 bypasses the regenerative heat exchanger 63 and the combustor 64. The second flow channel 82 connects the compressor 61 to the first through-hole 71i to the internal space 77 to the second through-hole 71o to the expander 62.

In the first flow channel 81, the compressor 61 compresses the working fluid. Subsequently, the regenerative heat exchanger 63 exchanges heat between the working fluid and turbine waste fluid, which raises the temperature of the working fluid. Subsequently, the combustor 64 injects fuel into the working fluid and burns the fuel. As a result, combustion gas is generated. Subsequently, an expander 62 expands the combustion gas. As the combustion gas passes through the expander 62, a torque is generated. The torque can be used to compress the working fluid by the compressor 61. In addition, by connecting a generator to the expander 62, the torque can be used to generate electricity by the generator. Subsequently, the turbine waste fluid that flows out of the expander 62 flows into the regenerative heat exchanger 63.

As can be understood from the above description, part of the working fluid flowing into the compressor 61 flows to the regenerative heat exchanger 63 and the combustor 64. Other part of the working fluid flowing into the compressor 61 flows into the second flow channel 82.

In the second flow channel 82, the working fluid flows into the internal space 77 through the first through-hole 71i. In the internal space 77, the working fluid cools the internal space 77. Subsequently, the working fluid flows out of the internal space 77 through the second through-hole 71. Subsequently, the working fluid flows into the expander 62. The working fluid that flows into the expander 62 in this manner can also contribute to the generation of torque in the expander 62. In addition, the working fluid that flows into the expander 62 in this manner can cool the expander 62.

In one specific example, the combustion gas is supplied to the turbine wheel 62w via a nozzle in the first flow channel 81. In contrast, the working fluid is supplied to the expander 62 in the second flow channel 82.

In general, to increase the torque produced by the expander, it is desirable that the working fluid flowing into the expander have a large heat capacity and a large mass. However, from the viewpoint of design of heat resistance, it is not desirable that the inlet temperature of the expander rise excessively.

For example, by dissipating the heat of the nozzle and the turbine wheel to the outside, the heat resistance of the nozzle and the turbine wheel can be ensured even when the inlet temperature of the expander is high. However, the design may reduce the torque produced by the expander since the heat of the combustion gas dissipates to the outside through the nozzle and the turbine wheel.

Accordingly, the present inventors conceived the idea of using a working fluid to cool the nozzle and the turbine wheel and supplying the working fluid to the intake side of the expander. In this manner, the amount of heat absorbed from the nozzle and the turbine wheel can be further used in the expander to generate torque. Furthermore, the working fluid that is cooler than the combustion gas can be mixed with the combustion gas, thus decreasing the intake air temperature of the expander without reducing the amount of heat in the intake air of the expander.

Furthermore, the present inventors conceived the idea of supplying, to the expander 62, the working fluid that has passed through the bearing structure 50. The working fluid that has passed through the bearing structure 50 is cooler than the nozzle and the turbine wheel, while the working fluid can have the amount of heat that contributes to the torque generation of the expander. For this reason, the working fluid that has passed through the bearing structure 50 can contribute to cooling the nozzle and/or turbine wheel and/or generating torque in the expander.

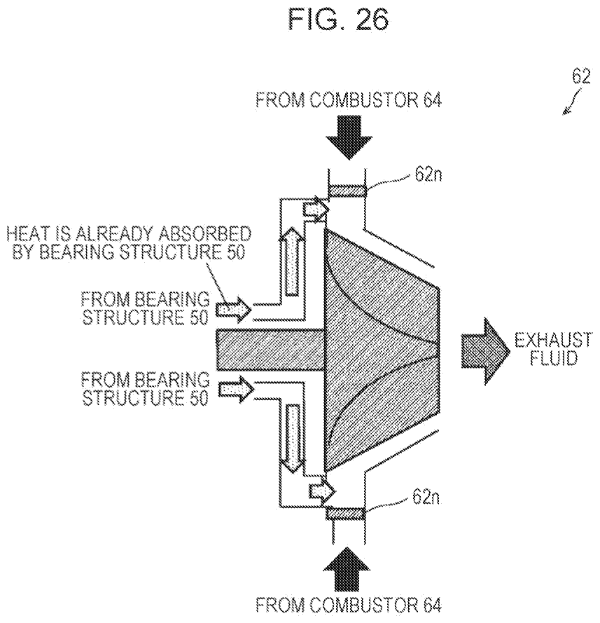

An example of the flow of the working fluid supplied from the bearing structure 50 to the expander 62 by the second flow channel 82 is described below with reference to FIGS. 26, 27, 28, 29, 30 and 31. More specifically, the flow of the working fluid discharged from the second through-hole 71o of the bearing structure 50 in the expander 62 is described below.

In the example in FIG. 26, the working fluid is supplied to the intake side and rotates the turbine wheel 62w in the expander 62. According to the example in FIG. 26, the amount of heat generated in the bearing structure 50 can be used to generate torque in the expander 62.

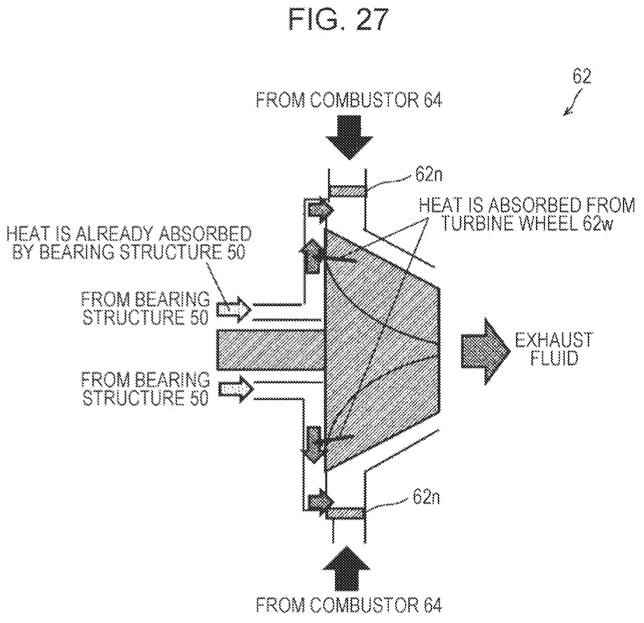

In the example in FIG. 27, in the expander 62, the working fluid cools the turbine wheel 62w and, thereafter, is supplied to the intake side to rotate the turbine wheel 62w. According to the example in FIG. 27, the amount of heat generated by the bearing structure 50 and the amount of heat absorbed from the turbine wheel 62w can be used to generate torque in the expander 62.

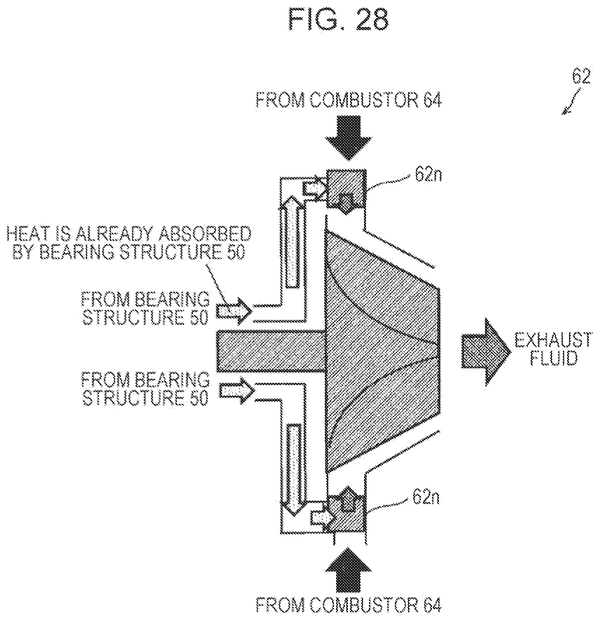

In the example in FIG. 28, in the expander 62, the working fluid cools a nozzle 62n and, thereafter, is supplied to the intake side to rotate the turbine wheel 62w. According to the example in FIG. 28, the amount of heat generated by the bearing structure 50 and the amount of heat absorbed from the nozzle 62n can be used to generate torque in the expander 62.

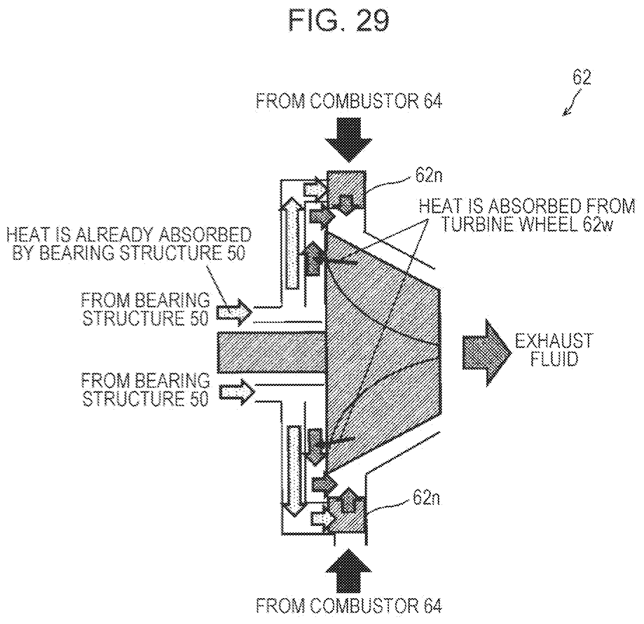

In the example in FIG. 29, part of the working fluid cools the nozzle 62n in the expander 62. Other part of the working fluid (more specifically, the remaining part) cools the turbine wheel 62w. The working fluid that has cooled the nozzle 62n and the working fluid that has cooled the turbine wheel 62w are supplied to the intake side to rotate the turbine wheel 62w. According to the example in FIG. 29, the amount of heat generated by the bearing structure 50, the amount of heat absorbed from the nozzle 62n, and the amount of heat absorbed from the turbine wheel can be used to generate torque in the expander 62.

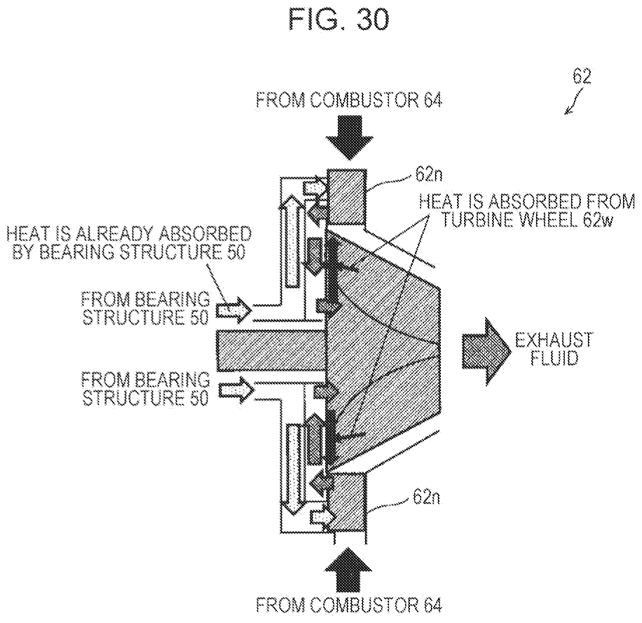

In the example in FIG. 30, in the expander 62, the working fluid cools the nozzle 62n and, thereafter, cools the turbine wheel 62w. Subsequently, the working fluid is supplied to the intake side to rotate the turbine wheel 62w. According to the example in FIG. 30, the amount of heat generated by the bearing structure 50, the amount of heat absorbed from the nozzle 62n, and the amount of heat absorbed from the turbine wheel 61w can be used to generate torque in the expander 62.

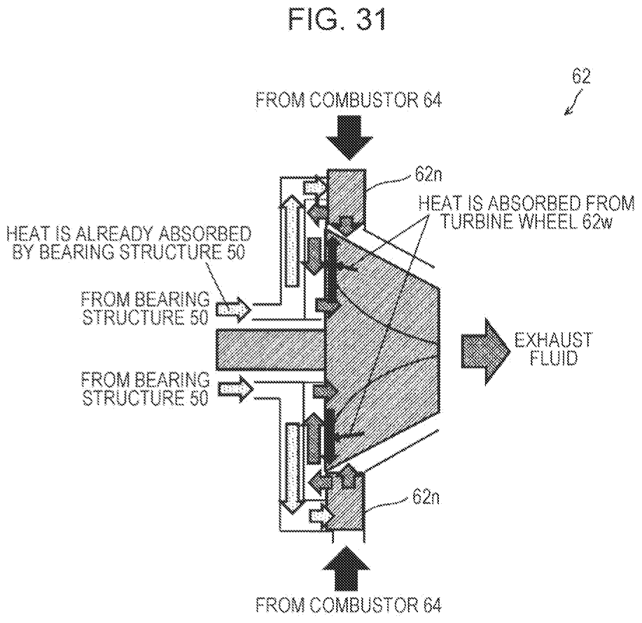

In the example in FIG. 31, the working fluid cools the nozzle 62n in the expander 62. Part of the working fluid that has cooled the nozzle 62n is supplied directly to the intake side. Other part (more specifically, the remaining part) of the working fluid that has cooled the nozzle 62n cools the turbine wheel 62w and, thereafter, is supplied to the intake side. Both parts of working fluid supplied to the intake side cause the turbine wheel 62w to rotate. According to the example in FIG. 31, the amount of heat generated by the bearing structure 50, the amount of heat absorbed from the nozzle 62n, and the amount of heat absorbed from the turbine wheel 61w can be used to generate torque in the expander 62.

The pressure of the working fluid according to one specific example is described below. Let Pc denote the pressure of the working fluid discharged from the compressor 61. Let ΔP1 denote the pressure drop of the working fluid in the regenerative heat exchanger 63. Let ΔP2 denote the difference obtained by subtracting the outlet pressure from the inlet pressure of the combustor 64. Then, a pressure Ptin1 of the combustion gas flowing into the expander 62 by the first flow channel 81 is given by the expression Ptin1=Pc−ΔP1−ΔP2. In addition, let ΔPtb denote the pressure drop of the working fluid in the bearing structure 50. Then, a pressure Ptin2 of the working fluid flowing into the expander 62 by the second flow channel 82 is given by the expression Ptin2=Pc−ΔP1. In the example in FIG. 2, Ptin2>Ptin1. In this way, the working fluid can be easily supplied to the bearing structure 50 and the expander 62 through the second flow channel 82. In addition, in the example in FIG. 2, the pressure of the turbine exhaust fluid is higher than the atmospheric pressure. For this reason, the turbine exhaust fluid can be easily discharged from the expander 62.

The temperature of the working fluid according to one specific example is described below. Let Tc denote the temperature of the working fluid discharged from the compressor 61. Let Trh denote the temperature of the working fluid immediately after discharged from the regenerative heat exchanger 63. Let Tb denote the temperature of the combustion gas discharged from the combustor 64. Let Ttb denote the temperature of the working fluid flowing out of the bearing structure 50. Due to heat exchange in the regenerative heat exchanger 63, Trh>Tc, and the temperature of the working fluid flowing into the combustor 64 is increased. Thus, the amount of fuel supplied to the combustor 64 can be decreased. In addition, although Ttb>Tc, Ttb is sufficiently low compared to Tb. As a result, the working fluid flowing out of the bearing structure 50 can cool the expander 62.

In FIGS. 22 to 25, an example of the position of the compressor 61 is illustrated when the bearing structure 50 is applied to the fluid machine 80. More specifically, in FIGS. 22 to 25, a centrifugal compressor 61 is illustrated.

As illustrated in FIGS. 22, 24, and 25, when viewed along the central axis 51c, the first through-hole 71i may be located on the axially outer side of the compressor impeller 61i. In this way, the flow rate of the working fluid flowing from the first through-hole 71i into the internal space 77 can be easily increased.

In one specific example, the working fluid that has passed through the compressor impeller 61i and the diffuser of the centrifugal compressor 61 flows into the internal space 77 through the first through-hole 71i. For example, when viewed along the central axis 51c, the first through-hole 71i is located at a position overlapping the diffuser or on the axially outer side of the diffuser.

However, when viewed along the central axis 51c, the first through-hole 71i may be located at a position overlapping the compressor impeller 61i.

According to the present embodiment, the bearing structure 50 supports a rotating part of the compressor 61. The rotating part includes the compressor impeller 61i. The rotating part rotates together with the rotating shaft 51. More specifically, like the rotating shaft 51, the rotating part rotates substantially about the central axis 51c.

When the temperature of the rotating shaft 51 changes, the rotating shaft 51 expands and, thus, the length in the axial direction 41 may change. Therefore, even if the bearing structure 50 maintains the position of the thrust collar 52, the position of the rotating part may change. According to the present embodiment, the axial direction 41 is the thrust direction.

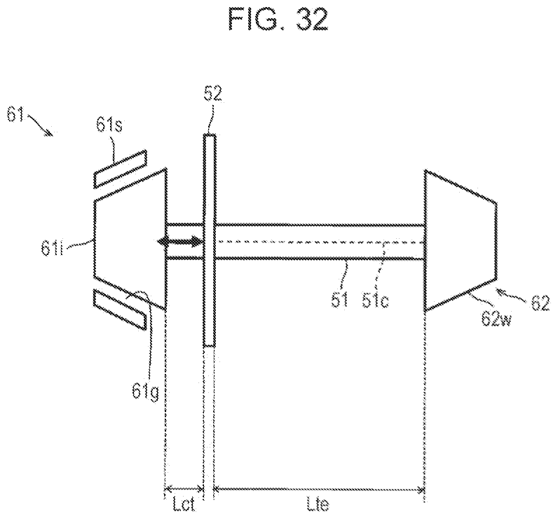

However, if the position of the rotating part in the axial direction 41 is accurately maintained, the loss in the compressor 61 can be reduced. According to the present embodiment, as illustrated in FIG. 32, the compressor 61 has a shroud 61s disposed at a fixed position. In this case, by accurately maintaining the position of the compressor impeller 61i in the axial direction 41, a small gap 61g can be maintained between the compressor impeller 61i and the shroud 61s while avoiding contact of the rotating compressor impeller 61i with the fixed shroud 61s. This can reduce the loss in the compressor 61 while avoiding failure of the compressor 61.

In this regard, according to the present embodiment, the relation Lct<Lte is satisfied, where Lct is the separation distance between the compressor 61 and the thrust collar 52 in the axial direction 41, and Lte is the separation distance between the thrust collar 52 and the expander 62 in the axial direction 41. According to the present embodiment, since Lct<Lte, the separation distance Lct can be easily reduced. As a result, the displacement of the compressor 61 in the axial direction 41 due to a temperature change in the rotating shaft 51 can be easily prevented.

More specifically, Lct represents the separation distance between the rotating part of the compressor 61 and the thrust collar 52 in the axial direction 41. Lte represents the separation distance between the thrust collar 52 and the rotating part of the expander 62 in the axial direction 41. Note that the rotating part of the expander 62 includes the turbine wheel 62w.

Still more specifically, Lct represents the separation distance between the compressor impeller 61i and the thrust collar 52 in the axial direction 41, and Lte represents the separation distance between the thrust collar 52 and the turbine wheel 62w in the axial direction 41.

The relation Lct<Lte is described in more detail below. According to the present embodiment, the relatively large separation distance Lte makes it difficult for the heat of the high-temperature expander 62 to be transferred to the thrust collar 52. Therefore, a change in the temperature of the expander 62 is less likely to influence the temperature of the portion of the rotating shaft 51 between the thrust collar 52 and the compressor 61. For this reason, it is easy to prevent displacement of the compressor 61 in the axial direction 41 caused by a variation of the separation distance Lct with a temperature change of the expander 62. For the above-described reason, the relation Lct<Lte is appropriate for the design of the fluid machine 80.

Furthermore, according to the present embodiment, the through-holes 71i and 71o are provided in the bearing structure 50. As a result, the temperature of the working fluid around the thrust collar 52 can be decreased, the temperature of the thrust collar 52 can be decreased, and the temperature of the rotating shaft 51 can be decreased. More specifically, the temperature of the portion of the rotating shaft 51 between the compressor 61 and the thrust collar 52 can be decreased. As a result, the displacement of the compressor 61 in the axial direction 41 caused by the temperature change of the rotating shaft 51 can be prevented. In terms of the expander 62, the through-holes 71i and 71o are provided so that the heat propagated from the expander 62 to the thrust collar 52 can be easily dissipated from the thrust collar 52 to the working fluid. For this reason, a change in the temperature of the expander 62 is unlikely to influence the temperature of the portion of the rotating shaft 51 between the thrust collar 52 and the compressor 61. This is advantageous from the viewpoint of preventing a variation of the separation distance Lct and preventing the displacement of the compressor 61 in the axial direction 41.

As described above, the fluid machine 80 according to the present embodiment can accurately maintain the position of the compressor 61 in the axial direction 41. As a result, it is expected to reduce the loss in the compressor 61.

### Another Mechanism

The above description has been made with reference to the mechanism M illustrated in FIGS. 11A to 11C. However, in reality, a mechanism other than the mechanism M can also work. For example, the centrifugal force can also work in the bearing structure 50.

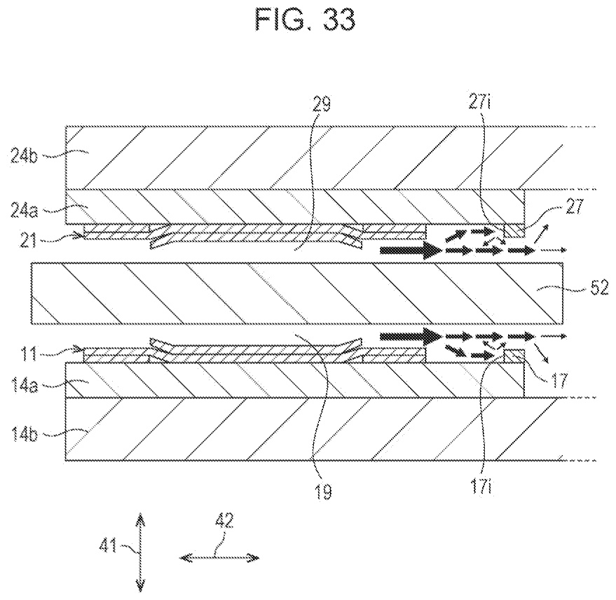

The advantages of the first convex portion 17 described above with reference to FIGS. 7 to 9 can be provided not only by the mechanism M but also by centrifugal force. More specifically, the first convex portion 17 acts to hold, on the axially inner side of the first convex portion 17, the working fluid that is about to flow outwardly from the gap 19 in the radial direction 42 due to the centrifugal force. This action can contribute to obtaining a large load capacity. The same applies to the second convex portion. In FIG. 33, the above-described holding action is schematically illustrated by arrows.

Various changes can be made to the present disclosure.

For example, the application of the technology of the present disclosure is not limited to turbine systems. Applications other than turbine systems include, for example, the rotating shafts of electric compressors, hard disc drives (HDDs) and the like, and processing equipment in factories.

In the example in FIG. 2, the first thrust bearing is located closer to the compressor than the second thrust bearing. However, the term “first thrust bearing” should not be interpreted as referring exclusively to the first thrust bearing located closer to the compressor.

While the above description has been given with reference to the case where both a first thrust bearing and a second thrust bearing are provided, an embodiment in which only one of the first and second thrust bearings is provided is also encompassed within the scope of the present disclosure.

A subset of the elements illustrated in the drawing can be removed. For example, the regenerative heat exchanger can be removed. Similarly, a subset of the elements of the bearing structure can be removed.

The bearing structure described in the above embodiment is applicable to turbine systems and the like.

What is claimed is:

1. A bearing structure comprising:
a rotating shaft having a central axis;
a thrust collar mounted on the rotating shaft; and
a first thrust bearing including a first dynamic pressure generating mechanism facing the thrust collar,
wherein a relation Rt>Rf1 is satisfied, where Rt represents a length from the central axis to an outer circumferential edge of the thrust collar, and Rf1 represents a length from the central axis to an outer circumferential edge of the first dynamic pressure generating mechanism.

2. The bearing structure according to claim 1, wherein the first thrust bearing includes a first stage and a first base,
wherein the first stage extends from the first base toward the thrust collar,
wherein the first dynamic pressure generating mechanism is provided on the first stage, and
wherein a relation Rs1<Rb1 is satisfied, where Rs1 represents a length from the central axis to an outer circumferential edge of the first stage, and Rb1 represents a length from the central axis to an outer circumferential edge of the first base.

3. The bearing structure according to claim 1, wherein the first thrust bearing includes a first stage,
wherein the first dynamic pressure generating mechanism is provided on the first stage, and
wherein a relation Rs1<Rt is satisfied, where Rs1 represents a length from the central axis to an outer circumferential edge of the first stage.

4. The bearing structure according to claim 1, wherein the thrust collar includes a first opposing plane that faces the first dynamic pressure generating mechanism and that extends in a direction perpendicular to the central axis, and
wherein a relation Ro1>Rf1 is satisfied, where Ro1 represents a length from the central axis to an outer circumferential edge of the first opposing plane.

5. The bearing structure according to claim 1, wherein the first thrust bearing includes a first stage,
wherein the first dynamic pressure generating mechanism is provided on the first stage, and
wherein a relation Rs1>Rf1 is satisfied, where Rs1 represents a length from the central axis to an outer circumferential edge of the first stage.

6. The bearing structure according to claim 1, wherein the first thrust bearing includes a first stage,
wherein the first dynamic pressure generating mechanism is provided on the first stage, and
wherein a relation Tf1<Ts1 is satisfied, where a direction in which the central axis extends is defined as an axial direction, Tf1 represents a dimension of the first dynamic pressure generating mechanism in the axial direction, and Ts1 represents a dimension of the first stage in the axial direction.

7. The bearing structure according to claim 1, wherein the first thrust bearing includes a first stage and a first convex portion,
wherein the first dynamic pressure generating mechanism is provided on the first stage,
wherein the first convex portion extends from the first stage toward the thrust collar, and
wherein when viewed along the central axis, the first convex portion is located on the axially outer side of the first dynamic pressure generating mechanism.

8. The bearing structure according to claim 7, wherein a relation Tf1>Tp1 is satisfied, where a direction in which the central axis extends is defined as an axial direction, Tp1 represents a dimension of the first convex portion in the axial direction, and Tf1 represents a dimension of the first dynamic pressure generating mechanism in the axial direction.

9. The bearing structure according to claim 1, wherein the first thrust bearing has a first concave portion, and
wherein the first dynamic pressure generating mechanism is provided in the first concave portion.

10. The bearing structure according to claim 9, wherein a relation Tf1>Tg1 is satisfied, where a direction in which the central axis extends is defined as an axial direction, Tg1 represents a dimension of the first concave portion in the axial direction, and Tf1 represents a dimension of the first dynamic pressure generating mechanism in the axial direction.

11. The bearing structure according to claim 1, wherein the first dynamic pressure generating mechanism includes a plurality of foil strips,
wherein the plurality of foil strips are arranged in an annular pattern so as to surround the rotating shaft, and
wherein every adjacent two of the plurality of foil strips partially overlap each other.

12. The bearing structure according to claim 1, wherein the thrust collar is plane symmetric with respect to a reference plane perpendicular to the central axis.

13. The bearing structure according to claim 12, wherein the thrust collar has a disk portion, a first hub portion, and a second hub portion,
wherein the first hub portion and the second hub portion sandwich the disk portion in an axial direction in which the central axis extends, and
wherein the first hub portion is plane symmetric to the second hub portion with respect to the reference plane.

14. The bearing structure according to claim 1, further comprising:
a casing; and
an enclosure including the casing and the first thrust bearing,
wherein the enclosure has an internal space,
wherein the first dynamic pressure generating mechanism faces the thrust collar in the internal space, and
wherein the enclosure has a first through-hole and a second through-hole that communicate with the internal space.

15. The bearing structure according to claim 14, further comprising:
a heat exchanger,
wherein the heat exchanger partitions the internal space into a first space and a second space,
wherein the first dynamic pressure generating mechanism faces the thrust collar in the first space, and
wherein the first through-hole and the second through-hole communicate with the second space.

16. A fluid machine comprising:
the bearing structure according to claim 1;
a compressor; and
an expander,
wherein the compressor and the expander are mounted on the rotating shaft.

17. A fluid machine comprising:
the bearing structure according to claim 14;
a compressor; and
an expander,
wherein the compressor and the expander are mounted on the rotating shaft, and
wherein working fluid discharged from the compressor flows into the internal space through the first through-hole.

18. The fluid machine according to claim 17, wherein the compressor is a centrifugal compressor,
wherein the centrifugal compressor includes a compressor impeller mounted on the rotating shaft, and
wherein as viewed along the central axis, the first through-hole is located on the axially outer side of an outer circumferential edge of the compressor impeller.

19. The fluid machine according to claim 16, wherein when a direction in which the central axis extends is defined as an axial direction, the compressor, the thrust collar, and the expander are arranged in this order in the axial direction, and
wherein a relation Lct<Lte is satisfied, where Lct represents a separation distance between the compressor and the thrust collar in the axial direction, and Lte represents a separation distance between the thrust collar and the expander in the axial direction.
